(19) United States
(12) Patent Application Publication
(10) Pub. No.: US 2026/0166554 A1
(43) Pub. Date: Jun. 18, 2026

(54) SYSTEM FOR PROVIDING MICROVESICLES HAVING A PREDEFINED SIZE AND/OR SIZE DISTRIBUTION

(71) Applicant: DEMCON curix B.V., ENSCHEDE (NL)

(72) Inventors: Ewout Rik JONKER, ENSCHEDE (NL); Wouter KLEIN HESSELINK, ENSCHEDE (NL); Martijn Peter TIBBE, ENSCHEDE (NL); Gerritdina Marieke OLSMAN, ENSCHEDE (NL); Jeroen Gerard RUITER, ENSCHEDE (NL); Peter Johan Anton FRINKING, ENSCHEDE (NL); Wilmer SCHROER, ENSCHEDE (NL); Steffen Georgius RESINK, ENSCHEDE (NL); Jos ANSINK, ENSCHEDE (NL); Jasmijn FRANKE, ENSCHEDE (NL); Joost Adriaan KAUFFMAN, ENSCHEDE (NL)

(73) Assignee: DEMCON curix B.V., ENSCHEDE (NL)

(21) Appl. No.: 19/126,501

(22) PCT Filed: Nov. 3, 2023
(86) PCT No.: PCT/NL2023/050580

§ 371 Date: May 1, 2025

(30) Foreign Application Priority Data
Nov. 4, 2022 (NL) 2033467

(51) Int. Cl. B01L 7/00; A47J 31/40; B01L 3/00

(52) U.S. Cl. CPC B01L 7/525; A47J 31/407; B01L 3/50273; B01L 3/502738; B01L 2200/027

(57) ABSTRACT

System for providing microvesicles, in particular microbubbles having a predefined size and/or size distribution, the system comprising means for receiving microvesicles in a microvesicle carrier liquid for obtaining a microvesicle containing heterogeneous mixture; a holding unit for holding the microvesicle containing heterogeneous mixture comprising the microvesicles and the microvesicle carrier liquid, in particular a saline solution; a uniformization mechanism that is arranged for uniformizing of the microvesicle containing heterogeneous mixture held in the holding unit; and a secondary reservoir containing microvesicle carrier liquid, in particular a saline solution, wherein the secondary reservoir is arranged in fluid connection with the holding unit.

The current invention relates to a system for providing microvesicles, preferably generating microvesicles, having a predefined size and/or size distribution, a disposable cartridge for use in such a system and a base system that is arranged for receiving said disposable cartridge.

Focused Ultrasound (FUS) in combination with gaseous microvesicles has emerged as a potential new means of effective drug delivery to the brain. Recent research has shown that, under burst-type energy exposure with the presence of microvesicles (e.g. nano/microdroplets, microcapsules, microbubbles), this modality can transiently permeate the blood-brain barrier (BBB). Microvesicles are heterogeneous membrane-bound objects having a core, such as a fluid (i.e. gas or liquid), that is enclosed by the outer membrane. Compositions used for generating such microvesicles are described in, for instance, European Patent EP 1784 288B1.

For an effective drug delivery, it is important that said microvesicles, typically microbubbles, have a predefined size and/or size distribution, wherein the distribution is preferably as narrow as possible. Existing systems for generating microvesicles typically lead to a too wide size distribution of the generated microvesicles. Additionally, in current systems, the microvesicles are typically generated in a dedicated system from which a microvesicles suspension, i.e. a heterogeneous mixture comprising the microvesicles and a microvesicles carrier liquid, results. Syringes are thereafter typically manually filled and connected to an infusion line for introducing the microvesicles in the circulatory (blood) system of a subject.

Due to this, the process is rather labour intensive with various options for human induced errors. The microvesicles suspension will further start to degenerate due to all the different handling steps, such that the drug delivery is not as effective as it could theoretically be.

It is therefore the goal of the invention to improve the quality of the generated microvesicles and thereby the effectiveness of the drug delivery by providing a system according to the invention wherein at least some the above presented problems are at least partially alleviated.

In a first aspect, the invention relates to a system for providing microvesicles, preferably having a predefined size and/or size distribution, according to claim 1, the system comprising:
means for receiving microvesicles in a microvesicle carrier liquid for obtaining a microvesicle containing heterogeneous mixture, in particular a microbubble carrier liquid for obtaining a microbubbles containing heterogeneous mixture;
a holding unit for holding the microvesicle containing heterogeneous mixture comprising the microvesicles and the microvesicle carrier liquid, in particular a saline solution;
a uniformization mechanism that is arranged for, preferably continuously, uniformizing of the microvesicles containing heterogeneous mixture held in the holding unit.

A disadvantage of the earlier described process according to the prior art is that, by separately generating the microvesicles, after which a syringe is manually filled and connected to an infusion line, the generated microvesicles and the microvesicle carrier liquid start to separate from each other directly after the generating step, whereby the concentration of microvesicles is no longer uniform and thereby the mixture degenerates. As in the system according to the invention, the obtained heterogeneous mixture is, preferably continuously, uniformized, the microvesicles can be stored for a longer period without degrading as due to the, preferable continuously, uniformization, the concentration of microvesicles of the mixture is kept substantially constant in the holding unit. It is noted that the continuous uniformization may also mean that the uniformization process may be performed with small breaks, or intervals, during the process. The uniformization mechanism is preferably arranged for uniformizing the heterogeneous mixture during, and/or at least just prior to, dispensing, i.e. administering, said microvesicles from the holding unit to, preferably, a subject. Hereby, the heterogeneous mixture is more uniform when compared to a heterogeneous mixture that is not uniformized, thereby enabling an improved treatment. Microvesicles having a gaseous core, are often referred to as microbubbles and can thus be considered as a special type of microvesicles.

As will be explained in greater detail below, the means for receiving the generated microvesicles may receive microvesicles generated externally, i.e., not in the system as described. Preferably, the system, then a system for generating microvesicles, comprises a microvesicle generating unit for generating microvesicles having a predefined size and/or size distribution, in particular a microbubble generating unit for generating microbubbles having a predefined size and/or size distribution, wherein said microvesicle generating unit comprises an inlet side that is arranged for receiving, through a first inlet, a first and, through a second inlet, a second fluid that are to be mixed by the microvesicle generating unit for generating the microvesicles and an outlet side that is arranged downstream and is arranged for expelling generated microvesicles.

Preferably, the system further comprises a secondary reservoir containing microvesicle carrier liquid, in particular a saline solution, wherein the secondary reservoir is arranged in fluid connection with the holding unit. The secondary reservoir allows microvesicle carrier liquid to be transferred to the holding unit, which beneficially allows, among other things, the dilution of microvesicle containing heterogeneous mixture in the holding unit if said mixture is present in the holding unit. This beneficially allows the microvesicle containing heterogeneous mixture to be stored at a relatively high concentration of microvesicles in the holding unit, to be only diluted prior to administering said mixture to a subject. Storing the microvesicle containing heterogeneous mixture at a higher concentration than the concentration which is intended for the mixture when it is administered to a subject, beneficially increases the stability of the microvesicles in said mixture.

Said system is preferably arranged for generating microvesicles, in particular microbubbles, having a predefined size and/or size distribution, more preferably having a size in the range of 0.1-20 μm, preferably 1-10 μm, most preferably 2-5 μm, or a size distribution according to the following specifications: the mode, median or mean in diameter of between 2 and 5 μm and a geometric standard deviation (GSD)<1.25, most preferably a GSD<1.1.

In a preferred embodiment, the holding unit comprises means for expelling said micro containing heterogeneous mixture from the holding unit for administering said microvesicle containing heterogeneous mixture, preferably under continuous uniformization by driving uniformization mechanism, to the subject in a precisely controlled way to a subject, preferably wherein said holding unit is in fluid communication with a connector, such as a luer type connector, that is arranged for coupling an infusion line that is arranged to be brought in fluid communication with the circulatory (blood) system of said subject.

As the holding unit can be brought in direct, selective, fluid contact with the subject for drug delivery, the step of manually filling a syringe and connecting it to an infusion line is prevented, such that this reduces the risk of a human error, as well as enabling to provide the continuously uniformized mixture to the subject, as that this significantly reduces the time span for the mixture between leaving the system and entering the circulatory system of said subject.

Preferably, the system further comprises a mixing unit in fluid communication with at least the holding unit and the connector via an outlet, wherein the mixing unit further comprises an inlet for receiving microvesicle carrier liquid, in particular saline, wherein the mixing unit is arranged to combine the microvesicle containing heterogeneous mixture from the holding unit and microvesicle carrier liquid to the mixing unit outlet for supply to the connector. This mechanism is also referred to as the “co-flow” mechanism.

It will be appreciated that this mechanism, as many of the following mechanisms as will be described, may also be applied in a generic system for providing microvesicles with means for receiving generated microvesicles and/or a holding unit only, i.e., without an uniformization unit and/or a secondary reservoir. Such a system will be referred to as a generic system in the following.

This allows the dilution of the microvesicle containing heterogeneous mixture with microvesicle carrier liquid, preferably saline, while the microvesicle containing heterogeneous mixture is transferred from the holding unit towards the connector, and optionally while the microvesicle containing heterogeneous mixture is administered to a patient, otherwise referred to as a subject. The additional dilution of the microvesicle containing heterogeneous mixture allows for an increase in flow rate of the microvesicle containing heterogeneous mixture without increasing the amount of microvesicles being administered. This increased flow rate beneficially prevents the microvesicle containing heterogeneous mixture from decanting during administration. In other words, the increased flow rate prevents the microvesicles from floating upwards in the mixture, and thereby potentially becoming entrapped inside the various fluid connections in the system, for example in the infusion line and connectors.

Preferably, the system is arranged to adjust the ratio of the microvesicle containing heterogeneous mixture and microvesicle carrier liquid flowing into the mixing unit. This adjustability allows the concentration of microvesicles that is administered to the subject to be adjusted based on requirements. The use of the mixing unit, also called the co-flow mechanism, allows the concentration of microvesicles in the microvesicle containing heterogeneous mixture stored in the holding unit to be set at a relatively high level. The possibility of diluting the microvesicle containing heterogeneous mixture from the holding unit during administration, also referred to as infusion, allows for a broad adjustment range for the actual concentration of microvesicles in the microvesicle containing heterogeneous mixture that is administered to the subject.

In addition, the adjustment of the ratio of the microvesicle containing heterogeneous mixture and microvesicle carrier liquid can be done during administration of the microvesicle containing heterogeneous mixture to a subject, allowing the concentration of microvesicles in the mixture that is administered to the subject to be adjusted during the administration process of the microvesicle containing heterogeneous mixture to said subject. As explained previously, storing the microvesicle containing heterogeneous mixture at a higher concentration of microvesicles improves the stability of said microvesicles in the microvesicle containing heterogeneous mixture. The use of the mixing unit beneficially allows the microvesicle containing heterogeneous mixture stored in the holding unit to be stored at a high concentration, only diluting said mixture to the desired concentration of microvesicles during administration of the (diluted) microvesicle containing heterogeneous mixture to a subject. Diluting the microvesicle containing heterogeneous mixture during administration is one of the latest moments to dilute said mixture, which maximizes the time that the microvesicle containing heterogeneous mixture can be kept at a higher concentration in the holding unit prior to administration to a subject.

Preferably, the holding unit comprises a holding container wherein a movable piston member is arranged, wherein the holding container and movable piston member enclose an interior volume for holding said microvesicle containing heterogeneous mixture and wherein said movable piston member is movable in the holding container for increasing or decreasing the internal volume, such that the said microvesicle containing heterogeneous mixture can be diluted, by adding the microvesicle carrier liquid to said microvesicle containing heterogeneous mixture in the holding unit, and/or expelled from the holding unit, wherein said movable piston member is preferably arranged to be driven by a first driving mechanism, in particular comprising a linear drive. Hereby, the holding container is enabled to directly administer the mixture held therein in a precisely controlled way, such that this significantly reduces the risk of a human error and the time span for the mixture between leaving the system and entering the circulatory system of said subject, as was described above.

In particular, a ratio between a volumetric change of the interior volume due to a unit length of stroke of the movable piston member multiplied by the unit length of stroke of the movable piston and the frontal surface area of the movable piston member multiplied by the unit length of stroke of the movable piston is ≤1. Such a ratio allows for a precise control of the amount of, and flow rate with which, the mixture that is administered. In a preferred embodiment, the ratio is <1, preferably <0.75, more preferably <0.5, most preferably <0.25, such that allows to deliver very small amounts of the mixture in a precise manner, as the interior volume change per stroke of length displacement of the piston is reduced. This can, for instance, be done by arranging a piston member having through holes therein, and/or having no fluid-tight seal between the piston member and interior wall of the holding container, whereby the effective change of the interior volume is determined by a driving part, such as a driving rod, of the piston member that is movable in, and out of, the holding container, thereby effectively modifying the interior volume of the holding container. The volumetric change per unit length of stroke is thereby dictated by the volume per unit length of the driving part.

In a preferred embodiment, the uniformization mechanism comprises a movable mixing element that extends into the holding unit; and wherein the system comprises a uniformization driving mechanism, in particular comprising a rotary drive, for driving said movable mixing element. By moving the movable mixing element through the heterogeneous mixture, the mixture remains stirred and thereby uniformized, thereby preventing a separation between the microvesicle carrier liquid and the generated microvesicles. The uniformization mechanism is in particular arranged for continuously uniformizing the microvesicle containing heterogeneous mixture that is held in said holding unit.

It is then preferred that the movable mixing element is comprised in the movable piston member, wherein the movable piston member is, preferably linearly, movable inside the holding container, in at least a direction substantially parallel to a longitudinal axis of holding container, and wherein the movable mixing element is a rotating mixing element, preferably comprising a plurality of fins that extend inside said interior volume, and is arranged to rotate with, or with respect to, the movable piston member;
wherein, in an embodiment, the movable piston member and movable mixing element comprise a shared shaft, wherein said shared shaft is rotatably connected to the movable mixing element and translationally connected to the movable piston member.

This prevents, on the one hand, that the movable mixing element and the movable piston member can collide and thereby become obstructed. On the other hand, as the movable mixing element moves with the movable piston member, the mixing element can remain in contact with the heterogeneous mixture even when the interior volume of the holding unit decrease due to administering portions of heterogeneous mixture held therewithin.

Preferably, the uniformization driving mechanism further comprises a releasable coupling for releasably coupling the movable piston member and/or the rotatable mixing element to the driving mechanism, wherein the releasable coupling comprises one or more movable annular coupling members comprising a protrusion arranged to engage with a recess or groove arranged on the movable piston member. This arrangement reduces the amount of movable parts required to construct a releasable coupling.

Preferably, the movable coupling members are slidably arranged in a locking sleeve and movable between a coupling state and a released state, wherein as the movable coupling members slide from the released state to the coupling state, the protrusions move inwards toward the centre axis of the locking sleeve. Preferably, the movable coupling members are arranged at, or near, one end of the locking sleeve.

This allows the protrusions to engage the recesses or groove arranged on the movable piston member. The coupling members sliding inwards move the protrusions inwards and away from the end of the locking sleeve, thereby securely engaging the movable piston member and pulling it towards the locking sleeve and/or an end stop, providing a well-defined connected-engaged-state of the releasable coupling and further increasing the security of the engagement.

Preferably, the movable coupling members comprise a cam portion which is arranged to engage with the locking sleeve, wherein as the movable coupling members move towards the coupled state, the cam portion engages with a part of the locking sleeve, thereby pushing the cam portion, at least part of the movable coupling member and the protrusion inwards towards the centre axis of the locking sleeve. This allows the protrusions to move towards the recesses or groove on the movable piston member to engage it.

Preferably, the releasable coupling further comprises a cap arranged on the end of the locking sleeve, wherein the cap comprises a hole to allow passage of at least part of the movable piston member and at least part of the mixing element, wherein the cap comprises an internal surface arranged to engage with the movable coupling members, preferably the cam portions of the movable clamp members, wherein said internal surface guides at least part of the movable coupling members outwards away from the centre axis of the locking sleeve as the coupling members move towards the released state.

This provides a positive guidance of the movable coupling members towards the coupled state and the released state, ensuring that the movable piston member is either securely coupled or fully released in respectively the coupled state and the released state of the coupling. The cap additionally serves to abut the movable piston member in the coupled state. In the coupled state, the movable coupling members pull the movable piston towards the cap to provide a secure and rigid coupling of the piston member and the driving mechanism.

Preferably, the uniformization driving mechanism further comprises a shaft connected to the uniformization driving mechanism, wherein the shaft is arranged to couple to the rotatable mixing element as defined above when the movable piston member is connected to the releasable coupling.

Preferably, the shaft is located on the inside of the locking sleeve. This concentric construction allows for a compact construction, with the locking sleeve providing an enclosure for the rotating shaft, protecting the shaft, as well as operators that operate the system.

In a preferred embodiment, the uniformization driving mechanism is arranged to alternatingly rotate the movable mixing element in the clockwise and counterclockwise directions. This prevents fluid in the holding unit, more specifically the microvesicle containing heterogeneous mixture from reaching a steady state, instead ensuring a continuously turbulent movement of liquid in the holding unit. This prevents decantation of the microvesicles in the microvesicle containing heterogeneous mixture in the holding unit.

Preferably, the system comprises a base system and a removably connected disposable cartridge, wherein said base system comprises releasable connecting means for holding the disposable cartridge in a predefined location and a predefined orientation, wherein said disposable cartridge comprises at least one of, preferably all of the microvesicle generation unit, the means for receiving said generated microvesicles in in a microvesicle carrier liquid, the holding unit and at least a part of the uniformization mechanism.

By effectively splitting the system between a disposable cartridge and a (re-usable) base system (i.e. base station), al the consumables and disposables, i.e. all the materials needed for the provision, and/or generation of the microvesicles, can be combined in a single cartridge, such that the system is easily prepared for producing microvesicles. In addition, this also allows to isolate, i.e. separate, all the re-usable parts of the system (such as controllers and/or drives) from (fluid) contact with the subject, such that these are not contaminated due to a direct fluid contact with the subject.

Preferably, the uniformization driving mechanism is arranged in the base system. This allows the driving mechanism to be used repeatedly rather than being disposed along with the disposable cartridge after use.

In a preferred embodiment and also applicable to a generic system for providing microvesicles, the second fluid is comprised in a sealed reservoir that is, or can be, arranged in the system, in particular in a sealed reservoir receiving section for receiving and holding said sealed reservoir that is arranged in the disposable cartridge, and, wherein, when the system is in an initialization state, the sealed reservoir is arranged to be opened, i.e. unsealed or wherein the seal is broken, punctured and/or ruptured, and
wherein the system, in particular the disposable cartridge, is arranged such that the second fluid in the opened container can be brought into fluid communication with the microvesicle generating unit.

It is noted that the sealed reservoir may also be a separate reservoir, and that said cartridge comprises a sealed reservoir receiving section for receiving and holding said sealed reservoir. This allows to position a correct amount of second fluid directly in the system, thereby preventing any possible mistakes or contamination compared to when an interior reservoir is to be filed manually. In particular, when the sealed reservoir is comprised in the cartridge, a correct and sealed (i.e. sterile) amount of second fluid is easily arranged in the system and made, upon opening, available to be directly used by the microvesicle generating unit.

It is then further preferred that the sealed reservoir is at least arranged to be held within the system, in particular is arranged to be received in a sealed reservoir receiving section for receiving and holding said sealed reservoir that is arranged in within the cartridge, and wherein an opening tool, e.g. a cutting, puncturing and/or rupturing tool, is arranged to be moved with respect to the sealed reservoir and/or sealed reservoir receiving section, or vice versa, to open the seal of the sealed reservoir for opening said sealed reservoir and wherein, preferably, a reservoir fluid conduit is arranged in, or with, the opening tool, wherein the reservoir fluid conduit is such, in the initialization state, an open end of the conduit is arranged to be inserted in the second fluid for bringing the second fluid in fluid communication with the microvesicle generating unit,
wherein the system comprises an opening tool driving mechanism, in particular a linear driving mechanism, for driving the opening tool with respect to the sealed reservoir, or vice versa. This allows for opening and accessing the reservoir of second fluid in a single, simple, action. The sealed reservoir may also be comprised by a sealed container, wherein any components that interact with the sealed reservoir, in particular the sealed reservoir receiving section, are also arranged to receive a sealed container.

Preferably, the system comprises a primary pressure regulation gaseous medium source that is arranged to be, when the system is in a microvesicle generating state that follows the initialization state, in fluid communication with the opened reservoir for forcing a flow of second fluid to the microvesicle generating unit. The second fluid can hereby be supplied to the microvesicle generating unit with a predefined flow and pressure, whereby any (mechanical) pumps are not required. Preferably, the primary pressure regulation gaseous medium is air, more preferably, the primary pressure regulation gaseous medium source is a pressurized container containing the air.

It is preferred that the system comprises a secondary pressure regulation gaseous medium source that is arranged for providing, as the first fluid, a flow of the pressurized gaseous medium and/or wherein said second fluid is a continuous phase fluid, in particular a liquid comprising stabilizing material such as for example a surfactant, polymers, lipids, proteins, preferably phospholipids. Suitable stabilizing materials are for instance disclosed in pars. [0033]-[0067] of European patent EP 1784 228B1. The microvesicles are formed by bringing the first fluid, i.e. the pressurized gas, together with the flow of second fluid in the microvesicles generating unit, whereby the pressurized gas is enclosed in a thin layer of the second fluid. In a particular embodiment, the primary and secondary pressure regulation gaseous medium source originate from the same source, in another embodiment, the primary and secondary pressure regulation gaseous medium source originate from different sources. Preferably, the secondary pressure regulation gaseous medium is biocompatible gas, gas precursor or mixture thereof. Preferred gasses are for instance, fluorinated gasses, such as sulfurhexafluoride (SF6) and/or perfluorocarbon gases, such as octafluoropropane (C3F8) or decafluorobutane (C4F10). Alternatively, the secondary pressure regulation gaseous medium is, or comprises, air, nitrogen, carbon dioxide, hydrogen, nitrous oxide; noble and/or inert gasses, such as helium, argon, xenon or krypton. Suitable biocompatible gasses are for instance disclosed in pars. [0083]-[0092] of European patent EP 1784 228B1. More preferably, the secondary pressure regulation gaseous medium source is pressurized container containing the respective secondary pressure regulation gaseous medium given above.

In a preferred embodiment and also applicable to a generic system for providing microvesicles, the base system comprises the primary and/or secondary pressure regulation gaseous medium source and a primary and/or secondary gaseous medium outlet(s);
wherein the disposable cartridge comprises a primary and/or secondary gaseous medium cartridge inlet(s) that is/are arranged to engage and cooperate with the primary and/or secondary gaseous medium outlet(s) for arranging a fluid connection between the primary and/or secondary pressure regulation gaseous medium source and the microvesicle generating unit and/or the sealed reservoir, preferably between the primary pressure regulating gaseous medium source and the sealed reservoir and between the secondary pressure regulating gaseous medium source and the microvesicle generating unit;
wherein said primary and/or secondary gaseous medium inlet(s) is/are preferably movably arranged in the cartridge and preferably comprise biasing means for urging said inlet(s), as seen in a state wherein the cartridge is coupled to the base system, towards the base system; and/or
wherein said primary and/or secondary gaseous medium outlet(s) is/are preferably movably arranged in the base system and preferably comprise biasing means for urging said outlet(s), as seen in a state wherein the cartridge is coupled to the base system, towards the cartridge.

This enables to separate the gas-source, i.e. a re-usable part of the system, from the disposables and/consumables, as is described above. In the most preferred embodiment, the respective inlet(s) is/are fixedly arranged in said cartridge and the respective outlet(s) is/are movable, as described here above.

Said biasing means may comprise a passive biasing mechanism, comprising for instance an elastic element, such as a (compression) spring, and may, alternatively or additionally, also comprise an active biasing mechanism, such as a pneumatic actuator having a pneumatic cylinder comprising a moveable piston rod that is arranged for moving the respective inlets(s) and/or outlet(s) towards and from, respectively, the base system and/or cartridge. In other words, the primary and/or secondary gaseous medium outlet(s) are arranged to be movable between a retracted position, wherein the outlet(s) are retracted into the base system, and an extended position wherein the outlet(s) are extended outwards towards the location of the disposable cartridge. This allows to disengage the fluid connection between the primary and/or secondary pressure regulation gaseous medium source and the microvesicle generating unit, such that the pressurized gas can be released to the surrounding environment and/or to depressurize the cartridge before decoupling and/or unlocking the cartridge from the base system, such that it can be safely removed from the base system. Also, the step of depressurizing the cartridge is an important step for safely administering said microvesicles to a subject, as this thereby prevents that pressurized gasses can, accidentally, be brought into fluidic contact with the circulatory system of the subject, when connecting subject to the system, by means of an infusion line, for administering the heterogenous mixture to the subject's circulatory system.

Preferably, the base system of the system or a generic system further comprises an outlet shield arranged to be movable between a closed position wherein the outlet shield covers the primary and/or secondary gaseous medium outlet(s), and an open position wherein the outlet shield uncovers the outlet(s). This outlet shield protects the outlet(s) and prevents the outlet(s) from being contaminated. In addition, the outlet shield being in the closed position can be used as a verification that the outlet(s) are disconnected from the disposable cartridge, and that the disposable cartridge is depressurized.

Preferably, the primary and/or secondary gaseous medium outlet(s) are arranged to block the outlet shield from moving from the open position towards the closed position when said outlet(s) are in the extended position, wherein the outlet shield is arranged to close only when said outlet(s) are in the retracted position. This prevents the outlet shield from closing when the outlet(s) are still in the extended position and potentially in contact with the cartridge, thereby preventing the outlet shield from registering as being closed when the outlet(s) are still extended.

Preferably, in the closed position, the outlet shield is arranged to seal the primary and/or secondary gaseous medium outlet(s). This allows the outlet(s) to be pressurized when the outlet shield is closed, allowing testing of pressurization function of the primary and/or secondary gaseous medium source(s), or other functionality relating to the outlet(s) being sealed. The sealing of the outlet(s) also further prevents contamination of the outlet(s). To improve the sealing, preferably the outlet shield comprises seals arranged to interact with the primary and/or secondary gaseous medium outlet(s) to seal said outlet(s).

Preferably, the system, or a generic system for providing microvesicles, additionally comprises a movable connector shield. Preferably, the movable connector shield is arranged at the connector for selectively covering and uncovering the connector, wherein the movable cover is preferably driven by a connector shield actuator. This connector shield can cover the connector used for connecting to an infusion line which may connect to the subject, thereby preventing an infusion line or any other object from being connected to the connector. This provides functionality for increasing the safety of the system, by preventing that a subject is connected to the system when certain conditions such as safety conditions are not met.

Preferably, the movable connector shield comprises biasing means arranged to bias the connector shield towards the covered position, covering the connector. As a result, the default position of the connector shield is the closed position. This further increases the safety providing functionality of the connector shield.

Preferably, the connector shield actuator is arranged to move the connector shield to uncover the connector when the pressure in the disposable cartridge is substantially equal to ambient pressure. This is part of the safety functionality of the system. It may be unsafe for the cartridge to be pressurized when it is connected to a subject. Therefore, the connector shield is arranged to only uncover the connector when the pressure in the cartridge is below a threshold, preferably approximately equal to ambient pressure.

Preferably, the connector shield actuator is arranged to move the connector shield to uncover the connector when the primary and/or secondary gaseous medium outlet(s) are disengaged from the primary and/or secondary gaseous medium inlet(s) and/or in the retracted position. When the outlet(s) are disengaged from the disposable cartridge, the disposable cartridge cannot be (re)pressurized. Ensuring that the outlet(s) are disconnected from the cartridge therefore further ensures that the a subject cannot be connected to the system when the cartridge is pressurized. Preferably, the outlet(s) can be re-engaged to the cartridge—preferably thereby triggering the connector shield actuator to close the connector shield and optionally only after confirming the closed position of the connector shield—to repressurize the cartridge after the outlet(s) have previously been disconnected from the cartridge. Said disconnection and reconnection of the outlet(s), and preferably the accompanying opening and closing of the connector shield, can preferably be cycled endlessly. This beneficially allows for a potential re-use of the cartridge, to blow primary and/or secondary gaseous medium through the cartridge to, among other things, clean the cartridge, and/or to allow the use of external microvesicle suspension (the use of said external microvesicle suspension is further explained below).

Preferably, the system, or a generic system, further comprises a safety controller operatively connected to the connector shield actuator, wherein the safety controller further comprises one or more sensors arranged for registering the pressure in the disposable cartridge and/or the state of the primary and/or secondary gaseous medium outlet(s), wherein the safety controller is arranged to command the connector shield actuator to open or close the movable connector shield on the basis of at least the pressure in the disposable cartridge and/or the state of the primary and/or secondary gaseous medium outlet(s). In the preferred embodiment, the safety controller is configured to only command the connector shield actuator to open the connector shield when the pressure in the disposable cartridge is at least approximately equal to ambient pressure, and when the primary and/or secondary gaseous medium outlet(s) are disconnected from the disposable cartridge. Preferably, the safety controller requires that the primary and/or secondary gaseous medium outlets to be retracted, and the outlet shield is closed, in order to allow the connector shield actuator to open the movable connector shield. Other safety conditions can also be programmed into the safety controller.

Preferably, the safety controller comprises a programmable electronic microcontroller, connected to the pressure sensing unit and the movable outlet shield, programmed to command the connector shield actuator based on the pressure in the cartridge and the position of the movable outlet shield. However, said safety controller may additionally or alternatively be comprised of mechanical components, and/or electronics. A mechanical interlinking can be constructed connecting the movable outlet shield, the pressure sensing unit and the outlet shield, wherein the mechanical interlinking only opens the connector shield when the outlet shield is closed and the pressure in the cartridge is approximately equal to ambient pressure.

In an alternative embodiment, the system is arranged for receiving generated microvesicles in an external microvesicle suspension, comprising pre-made microvesicles in a microvesicle carrier liquid, in the holding unit. In this embodiment the microvesicles are thus not generated in the disposable cartridge. This alternative embodiment beneficially allows for a broader range of microvesicles or other compounds to be administered by the system.

In this embodiment, the external microvesicle suspension is comprised in a sealed reservoir that is, or can be, arranged in the system, in particular in a sealed container receiving section for receiving and holding said sealed container that is arranged in the disposable cartridge, and wherein the system, in particular the disposable cartridge, is arranged such that the external microvesicle suspension in the opened container can be brought into fluid communication with the holding unit. Preferably, a reservoir fluid conduit is arranged to bring the external microvesicle suspension in fluid communication with the holding unit.

In the embodiment using external microvesicle suspension, the microfluidic chip, as well as the secondary pressure regulation gaseous medium used for generating microvesicles are not required. However, it is not necessary to remove these components in order to use an external microvesicle suspension in combination with the disposable cartridge. Preferably, the reservoir containing the external microvesicle suspension, preferably a vial of sorts, is connected through a reservoir fluid conduit to a fluid connection on the cartridge. Preferably the reservoir fluid conduit comprises a tube and connector arranged to connect the reservoir to a connector arranged on the cartridge, wherein said connector is in fluid communication with the holding unit.

Preferably, said connector is the same connector as the connector that is arranged for coupling an infusion line that is arranged to be brought in fluid communication with the circulatory system of said subject. The external microvesicle suspension may then be transferred to the holding unit by first making said fluid connection, and subsequently increasing the volume of the holding unit to generate a negative pressure, or lower pressure, relative to the pressure in the reservoir containing the external microvesicle suspension that draws the external microvesicle suspension into the holding unit. By connecting to the said connector also used for connecting to an infusion line for administering a fluid, in particular microvesicle containing heterogeneous mixture, to a subject, the microfluidic chip may be bypassed.

Vials are known in the art which are supplied in a sealed state, together with a cap comprising a tool to open the vial and form a fluid connection to a fluid conduit such as a tube, which fluid conduit can then be connected to the cartridge, more specifically to the cartridge connector, which preferably is a connector of the luer type.

Preferably, the system, or a generic system, comprises a first optical scanner, arranged to scan a visual code arranged on the sealed reservoir. This allows an (automatic) verification of presence and type of the sealed reservoir arranged on the disposable cartridge. The visual code may be any visual code known in the art, such as a bar code and/or a QR code. Preferably, the first optical scanner is arranged on the base system. This allows the relatively expensive component to be used repeatedly rather than being discarded after use with the disposable cartridge.

Preferably, the visual code is arranged on the bottom of the sealed reservoir. Preferably the first optical scanner is arranged to scan the bottom of the sealed reservoir when the sealed reservoir is arranged on the disposable cartridge. This allows the sealed reservoir to be arranged at any angle in the sealed reservoir receiving section while keeping the visual code visible to the optical scanner.

Preferably, the base system comprises a second optical scanner, arranged to scan a visual code arranged on the disposable cartridge. This cartridge visual code may similarly be any visual code known in the art, such as a bar code and/or a QR code. The second optical scanner may thus be used to verify the presence of and type of disposable cartridge that is arranged on the base system.

Preferably, the system, or a generic system, comprises a locking mechanism having a released and locked state, wherein, in the released state, the disposable cartridge is removable from the base system and wherein, in the locked state, the disposable cartridge in fixedly held in the base system and urged, by the locking system, towards the base station with a preload force, wherein the locking system preferably comprises a locking drive mechanism for driving said locking mechanism. This allows to securely lock the cartridge in place, such that, upon activating for instance the pressured gas sources, the cartridge is firmly and securely held in place and enabled to cope with therefrom resulting reaction forces.

It is then preferred that the locking mechanism comprises a first movable, in particular rotatable, clamping unit that is arranged in the base station and arranged to engage a first clamping portion of the cartridge, that is preferably arranged at a lower section of the disposable cartridge, and urge said clamping portion in a first direction towards the base station and urge said clamping portion in a second direction that substantially parallel to the base station and preferably perpendicular to the first direction and wherein the locking mechanism further comprises a second movable clamping unit that is arranged to engage the cartridge at a second clamping portion that is different from the first clamping position, that is preferably arranged at an upper section of the disposable cartridge, and urge said second location in the first direction. This enables to secure the cartridge in a unique position and orientation to the base system.

Preferably, in the locked state, the locking mechanism, in particular the respective movable clamping units, is arranged for applying the preload force onto a section of the cartridge comprising the, preferably movable, first and/or second gaseous medium inlet(s) and/or outlet(s). Hereby, the preload is transferred, at least in part, to the connection between the respective inlets(s) and outlets(s), such that a gas-tight interface between the disposable cartridge and the base system is obtained.

Preferably, the locking mechanism is biased towards the locked state, more preferably such that without actuation by the locking drive mechanism the locking mechanism is moved or kept in the locked state. Accidental removal of the cartridge is then prevented, also in case of any malfunction of the locking drive mechanism.

Preferably, the locking mechanism comprises a clamping mechanism comprising the second movable clamping unit and a locking drive mechanism, wherein the locking drive mechanism is arranged to move the clamping mechanism, wherein said clamping mechanism is arranged to move the clamping unit between the locked state and the released state, wherein the clamping mechanism is arranged to move through a dead point between the locked state and the released state. Preferably, in said dead point a force acting in a direction opposite the direction of the movement of the clamping unit is not transferred to the actuator. In other words, the dead point defines a threshold for moving the clamping unit from the locked to the released state. Any force exerted below said threshold will not move the clamping unit to the released state.

As the clamping mechanism has to move through a dead point between the locked and the released state, a force pushing against the clamping unit in the locked state cannot move the clamping mechanism to the released state, as the force only acts to force the mechanism towards the locked state.

Preferably, the clamping mechanism comprises a rotating member rotatably arranged on the base system using a first pivot, a rotating clamping unit rotatably arranged on the base system using a second pivot, and a linkage connecting to the rotating member with a first hinge located at a nonzero offset to the first pivot, and to the rotating clamping unit with a second hinge located at a nonzero distance from the second pivot, wherein a rotation of the rotating member is transferred by the linkage to the clamping unit thereby rotating the clamping unit, wherein a dead point state occurs when the clamping mechanism is in a position wherein the first pivot, the first hinge and the second hinge align.

Preferably, a line drawn through the first and the second pivot defines a dead point line separating a locked side and a released side, wherein the first hinge is on the locked side in the locked state and on the released side in the released state, and on the dead point line in the dead point state. Preferably, the locking drive mechanism is arranged to push against the rotating member to rotate the rotating member. This mechanism provides a geometry which has a dead point when moving between the locked and unlocked states.

Preferably, the clamping unit comprises a biasing means arranged to transmit a clamping force applied by the clamping mechanism to the disposable cartridge.

As the clamping mechanism moves through the dead point, the clamping unit moves beyond the position it would be in in the locked state. In principle this will cause the clamping unit to be pushed into the disposable cartridge further than is intended, potentially damaging the cartridge. By arranging a biasing means to transmit the clamping force applied by the clamping mechanism to the disposable cartridge, this movement of the clamping unit is absorbed by the biasing means instead of transmitted to the disposable cartridge. This prevents the cartridge from being damaged as the clamping mechanism moves through the dead point.

Preferably, the clamping unit comprises a separate clamp and a clamp lever, wherein the clamp and clamp lever are rotatably arranged around the second pivot, wherein the clamp lever comprises the second hinge, wherein the biasing means is arranged between the clamp and the clamp lever, wherein a rotation of the clamp lever is transmitted only by the biasing means to the clamp.

This arrangement allows for a compact construction of a clamping unit comprising a biasing means. As the clamp lever and clamp rotate to each other the biasing means is compressed. Preferably, the biasing force provided by the biasing means is chosen to be sufficiently high to securely retain the disposable cartridge, as the biasing means is the only component transferring a retention force from the clamping mechanism to the disposable cartridge. Preferably, the biasing force is sufficiently low to prevent damage to the disposable cartridge as the biasing means is compressed when the clamping mechanism moves through the dead point state.

In a preferred embodiment of the system or a generic system, the base system and disposable cartridge comprise mutually cooperating recesses and protrusions for aligning said disposable cartridge in the base system, preferably wherein said cooperating recesses and protrusions are arranged such that the cartridge only has a single unique fit with which it can be placed and coupled in the base system. This enables to further reduce any human error that can be made in the process and thereby further aids in increasing the effectiveness of the drug delivery method.

It is preferred that the microvesicle generating unit comprises a microfluidic chip, in particular a microfluidic flow-focusing chip, comprising a first chip inlet for receiving the first fluid and a second chip inlet for receiving the second fluid, wherein channels extending from the first and second chip inlet converge at a junction from which a vesicle formation channel extends towards a chip outlet for expelling the generated microvesicles from the microfluidic chip towards the outlet side of the microvesicle generating unit. Such a microfluidic flow-focusing chip enables, in a generating state, to generate a continuous stream of generated microvesicles having the predefined size and/or size distribution. It will be appreciated that this mechanism is also applicable to generic systems not provided with for instance an uniformization unit.

Preferably, the system further comprises a heat transfer element that is arranged for heating and/or cooling said a micro-fluidic chip. This allows to control the temperature at which the microvesicles are generated, such that an improved control of the size and/or size distribution of the microvesicles is obtained.

In a preferred embodiment, the heat transfer element is arranged in base system and is arranged to abut, in at least a connected state wherein the disposable cartridge is connected to the base system, a section of the cartridge comprising the microvesicle generation unit, in particular the microfluidic chip, in particular to directly abut the microvesicle generation unit, in particular the microfluidic chip. The contact allows a good heat transfer from the heat transfer element to the microvesicle generation unit, in particular the micro-fluidic chip, such that the temperature of the microvesicle generation unit, in particular the microfluidic chip is accurately controllable.

Preferably, the heat transfer element is movably arranged within the base system along the direction towards, and away from, the disposable cartridge and wherein the heat transfer element is urged, by means of a heat transfer element biasing mechanism, in the direction towards the disposable cartridge. Hereby, a proper contact between the heat transfer element and the disposable cartridge, in particular the microvesicle generation unit, more in particular the microfluidic chip is ensured.

Preferably, the heat transfer element is further movably arranged within the base system in a direction having an orthogonal component to the direction towards, and away from, the disposable cartridge, and wherein the heat transfer element is preferably additionally rotatably arranged in the base system around all three perpendicular directions, wherein the base system and heat transfer element are arranged to limit the translational movement along the two said directions to a displacement that is smaller than the displacement allowed in the direction towards and away from the disposable cartridge, wherein the base system and heat transfer element are additionally arranged to limit the rotational movement of the heat transfer element to less than 10°, preferably less than 5°, more preferably less than 2°, most preferably approximately 1.5° around each of the three perpendicular axes.

These additional degrees of freedom allow the heat transfer element to adjust to a slightly deformed disposable cartridge and/or microfluidic chip to ensure optimal contact with the disposable cartridge, in particular the microfluidic chip.

Preferably, the heat transfer element comprises a heat transfer element shaft extending through the guide section and cooperating with the guide section to guide the heat transfer element, wherein at least one diametric dimension of the heat transfer shaft is smaller than a corresponding diametric dimension of the guide section, wherein the difference in diameter of the heat transfer element shaft and the guide section allows for at least one degree of rotation and/or at least one degree of translation along at least one direction perpendicular to the primary axis. This allows for a simple construction of the heat transfer element and the guide section.

In a preferred embodiment, the micro-fluidic chip is placed in the disposable cartridge in such a manner that, in an unconnected state with the base station, a limited movement between the chip and cartridge is allowed and/or wherein, in a connected and/or locked state, the chip is urged towards the cartridge, or vice versa, for obtaining a fluid-tight fluidic coupling between the fluidic circuit of the cartridge, that is arranged for guiding the first and second fluids through the cartridge, and the micro-fluidic chip. Preferably, the chip comprises a plurality of chip in-and/or outlets, wherein said in-and/or outlets are in fluid connection with the fluidic circuit of the cartridge, wherein a flexible sealing member, in particular an O-ring that is preferably made from an elastomeric or rubber material, is arranged between said chip and said cartridge, and wherein, upon urging the chip towards the cartridge, or vice versa, the flexible sealing member is pressed between said chip and cartridge for obtaining the fluid-tight hydraulic coupling. This allows for a simple and robust (fluid-tight) coupling between the chip and cartridge, such that the microvesicles are generated under constant conditions, thereby resulting in a substantially equal size and/or size distribution. It should be noted that this function can also be performed in the absence of heating the microfluidic chip. In this embodiment, the heat transfer element simply functions as a biasing means to correctly position the microfluidic chip in the disposable cartridge. It is further preferred if internal filter members are arranged at the fluid-tight fluidic coupling in between the fluidic circuit of the cartridge and the micro-fluidic chip. The internal filter members have preferably pores, i.e. openings, that are in the order 0.25-2 times the size of the smallest channels arranged in the micro-fluidic chip, more preferably in the order of 0.5-1.5 times the size of the smallest channels arranged in the micro-fluidic chip. This reduces the chance that the channels are blocked by any particles that are present in the system, thereby increasing the reliability of the process of generating microvesicles. In addition, the safety of the system is further improved, as residue is caught by the filters. The respective internal filters may thereby be applied in the hydraulic coupling that is arranged for guiding the second fluid, in particular the second liquid and/or may be applied in a respective gas coupling that is arranged for guiding the first fluid, in particular the pressurized gas. Alternatively, or additionally, said internal filter may also be integrated (e.g. directly formed in) in the micro-fluidic chip itself.

Preferably, any of the above described respective driving mechanisms comprises a driving unit, such as an electric, pneumatic or hydraulic motor or a combination of these, and wherein a driving unit of a respective driving mechanism is arranged in the base system and releasably and operatively coupled to a part of the respective driving mechanism that is arranged in the disposable cartridge. This enables the effective split of the system between a disposable cartridge and a (re-usable) base system (i.e. base station), as was described above. Preferably, the respective driving units comprise a pneumatic motor that is powered by the primary pressure regulation gaseous medium source. The use of pneumatic drives enables to obtain a MRI safe device.

In a preferred embodiment, the system or a generic system, in particular the disposable cartridge, comprises a secondary sealed reservoir containing the microvesicle carrier liquid, in particular a saline solution, wherein, in the initialization phase, the secondary sealed reservoir is arranged to be opened and arranged to be in fluid communication with the holding unit. This enables to collect all consumables in the single disposable cartridge, such that for a drug delivery treatment, the system is easily prepared and any human error is reduced as much as possible.

It is then preferred that the secondary sealed reservoir comprises a movable sealing element that is, before use, arranged to remain in a sealing position wherein the movable sealing element seals the secondary sealed reservoir and that, when in the initialization phase, is moved to an opening position, whereby the secondary reservoir is in fluid communication with the holding unit. The use of sealed reservoirs enables to keep the respective liquids sterile for a longer period of time and to prevent evaporation of the liquids, thereby being able to guarantee the effective drug delivery for an enhanced period of time.

In an embodiment, the secondary sealed reservoir is arranged to be opened by increasing an internal pressure in the secondary sealed reservoir to a predefined minimum pressure. This enables an easy unsealing of the reservoir that does not rely on punction, rupturing or otherwise removing of opening of a fixed seal.

Alternatively, or additionally, the secondary sealed reservoir is arranged to be opened upon coupling, and/or locking, of said cartridge in said base system. Hereto, the base system may be arranged with a fixedly arranged protruding member that is arranged to abut and push a movable sealing member from a sealed position wherein the movable sealing element covers an opening (i.e. an inlet/outlet) of the secondary sealed reservoir upon the coupling, and/or locking, of said cartridge.

In a preferred embodiment, the movable sealing element is movable between three positions comprising a sealing position, an opening position, and a filling position wherein the secondary sealed reservoir is opened to receive fluid from a source outside the disposable cartridge. Hereto, the base system may be arranged with a fixedly arranged protruding member that is arranged to abut and push the movable sealing member from a sealed position wherein the movable sealing element covers an opening (i.e. an inlet/outlet) of the secondary sealed reservoir upon the coupling, and/or locking, of said cartridge.

The additional filling position allows for the filling of the secondary sealed reservoir of the disposable cartridge, for example during production of the disposable cartridge. By moving the movable sealing element to the sealing position after sealing, the secondary reservoir is sealed.

Preferably, the movable sealing element is movably arranged in a sealing element holding channel in the cartridge, wherein the movable sealing element and the sealing element holding channel interact to form a valve for opening and sealing the secondary sealed reservoir, wherein the diameter of the movable sealing element is preferably at least at one point smaller than the diameter of the sealing element holding channel. It should be noted that other ways to form a fluid passage are also possible, for example by providing a through hole in the movable sealing element that provided a fluid passage from the opening of the secondary sealed reservoir and the opening in the sealing element holding channel that leads to the holding unit. In this embodiment it is not required that the diameter of the movable sealing element is at any point smaller than the diameter of the sealing element holding channel.

Preferably, the movable sealing element comprises at least three seals, in particular O-rings, arranged around its circumference, wherein a third seal is located near the end of the movable sealing element pointing into the cartridge, the first seal near the end of the movable sealing element pointing out of the cartridge, and the second seal is located in between the first and the third seal. Preferably, the movable sealing element comprises an axial hole extending through the length of the movable sealing element. Preferably, the diameter of the movable sealing element is smaller than the diameter of the sealing element holding channel at least between the second and first seals.

Preferably, the sealing element holding channel comprises an open end and a closed end, and at least two openings in the channel wall, at least a first opening providing a fluid connection between the sealing element holding channel and the secondary sealed reservoir, and at least a second opening providing a fluid connection between the sealing element holding channel and the holding unit, wherein the first and second openings are arranged at different distances from the closed end of the sealing element holding channel. Preferably, the valve is arranged to be movable between a filling position, a sealing position and an opening position.

Preferably, in the filling position, the movable sealing element is in a position wherein the third seal is located on open end side of the sealing element holding channel, wherein a passage is formed from the exterior of the cartridge through the opening in the movable sealing element towards the first opening, towards the secondary sealed reservoir. Preferably, in the sealed position, the movable sealing element is in a position wherein the third and second seals are located on opposing sides of the first opening, thereby sealing the secondary sealed reservoir. Preferably, in the opening position, the movable sealing element is in a position wherein the second seal is located on the closed end side of the sealing element holding channel of the first opening, and the first seal is located on the open end side of the sealing element holding channel of the second opening. In other words, the second and first seal are located on opposing sides of both the first and second openings in the opening position of the valve, forming a fluid connection from the first to the second opening through a gap between the movable sealing element and the sealing element holding channel wall, allowing fluid to flow between the secondary sealed reservoir and the holding unit.

The described embodiment allows for an efficient workflow in filling, sealing and unsealing the secondary sealed reservoir. During production the movable sealing element is in the filling position, and it can then be pushed inwards towards the sealing position. A seal can be applied to the movable sealing element to prevent it from being accidentally pushed inwards towards the opening position during handling. Preferably, the movable sealing element cannot be easily moved from the sealing position to the filling position, for example by not having the movable sealing element protrude significantly from the disposable cartridge in the sealing position, preventing it from being gripped and pulled out. This prevents the secondary sealed reservoir from being accidentally opened towards the filling position, potentially emptying the secondary reservoir and/or contaminating the contents of the secondary sealed reservoir. Other measures to at least to some extent retain the movable sealing element in the sealed position during storage of the disposable cartridge are envisioned, such as a locking means, comprising for example a snap mechanism or another known locking geometry and/or mechanism, and/or a removable or breakable seal. Means to retain the movable sealing element in other positions, such as the filling position or the opening position are also envisioned, for example a snap mechanism or other retention mechanism known in the art that can retain the movable sealing element in multiple different positions.

Preferably, the secondary sealed reservoir is arranged such that, after opening, the movable sealing element is, in the connected and/or locked state, restrained from moving back to the sealing position, such that the secondary (un)sealed reservoir remains open. This allows to, for instance, use the secondary reservoir as a waste container for collecting any residual liquids that remain in the cartridge after the microvesicles are generated and administered. Hereby, the liquids can, after removal of the cartridge, be easily drained from the cartridge and separately disposed. This enables in improved separation of any waste. Alternatively, or additionally, the sealed reservoir is arranged, in the connected and/or locked state, to remain opened after opening, such that the opened up sealed reservoir acts as a waste container, as described above.

It is preferred that an optional movable sealing element biasing mechanism is arranged for, when the cartridge is in the unconnected and/or released state, urging said movable sealing element to the sealed position for closing said secondary sealed reservoir. Any of the waste that is collected in the secondary reservoir is thereby restrained in the reservoir and is prevented from accidentally spilling.

As explained before, the concentration of the microvesicle containing heterogeneous mixture that is administered to, or infused in, the subject can be adjusted in the mixing unit, in which a flow of microvesicle carrier liquid, preferably saline, is combined with a flow of microvesicle containing heterogeneous mixture from the holding unit. Preferably, this mixing unit is placed in fluid connection with the secondary sealed reservoir and the holding unit, and the connector. The ratio of the mixture of the microvesicle containing heterogeneous mixture from the holding unit and the microvesicle carrier liquid from the secondary sealed reservoir can then be adjusted by adjusting the flow rates from both the holding unit and the secondary sealed reservoir.

Preferably, the system also comprises an operational controller for controlling the respective drives, actuators, heat transfer elements and valves for operating the system. The operational controller may further be arranged for receiving and processing sensor data input, which may be fed back in a loop to the control of the respective drives, actuators, heat transfer elements and valves. The operational controller may also comprise the aforementioned safety controller, or vice versa. Both controllers, for example, can be comprised in a single control unit. Alternatively, both the operational and safety controller are separate components, and the safety and operational controller may then be operationally connected to allow both controllers to communicate. However, it is not essential that the safety controller and operational controller are in communication or otherwise cooperate.

Preferably, the system, or a generic system, further comprises a sensing unit comprising a first light source and a first light sensor, further comprising a monitoring fluid line wherein light originating from the first light source is directed through the monitoring fluid line towards the first light sensor in the presence of the microvesicle containing heterogeneous mixture in the monitoring fluid line, wherein the sensing unit is preferably arranged to determine the concentration of microvesicles in the microvesicle containing heterogeneous mixture based on the intensity of light received by the first light sensor. Measuring the presence, or concentration, of microvesicles optically prevents deterioration of the microvesicles associated with for instance ultrasonic measurements.

Preferably, the presence or concentration of microvesicles in the microvesicle containing heterogeneous mixture is measured by measuring the transmittance of the microvesicle containing heterogeneous mixture. The presence of liquid in the monitoring fluid line, more in particular saline containing microvesicles, most in particular microvesicle containing heterogeneous mixture causes the refractive index of the monitoring fluid line and the fluid therein to be such that light beam received from the first light source is transmitted through the monitoring fluid line and the liquid therein towards the first light sensor. This allows for an accurate measurement of the concentration of microvesicles in the microvesicle containing heterogeneous mixture to be taken without requiring additional components to be arranged within the fluid stream in the cartridge. The concentration measurement can be used as an input for the aforementioned operational controller, and can for example be used to regulate the ratio wherein the microvesicle containing heterogeneous mixture is diluted with microvesicle carrier liquid in the mixing unit.

Preferably, the base system further comprises a second light sensor, wherein light originating from the first light source which is reflected by the monitoring fluid line is directed towards the second light sensor, wherein the sensing unit is arranged to determine the presence of gas in the monitoring fluid line based on light received by the second light sensor.

The absence of liquid and the resulting presence of gas in the fluid lines, in particular the monitoring fluid line, or (large) pockets of gas present in the fluid in the monitoring fluid line changes the refractive index of the monitoring fluid line to be such that light received from the direction of the first light source is reflected by the monitoring fluid line in the direction of the second light sensor. Therefore, if the second light sensor registers light the absence of liquid in the monitoring fluid line can be detected.

Preferably, the first light source and the first and second light sensors are arranged in the base system, while the monitoring fluid line is arranged in the disposable cartridge. This allows these relatively expensive components to be used repeatedly, rather than being disposed together with the disposable cartridge after use.

Preferably, the disposable cartridge comprises one or more reflective surfaces to reflect light received from the first light source towards the monitoring fluid line, and preferably one or more reflective surfaces to reflect light transmitted through the monitoring fluid line towards the first light sensor, and to reflect light reflected by the monitoring fluid line towards the second light sensor. This allows the light source and light sensors to be arranged in the base system pointing outwards, which allows for a simple construction. Having the light source(s) and light sensors arranged substantially flush to the outer surface of the base system additionally beneficially allows for easier cleaning of the base system. In addition, said substantially flush arrangements allows for a smooth surface that interfaces with the disposable cartridge, reducing complexity of both the base system and the disposable cartridge.

An alternative embodiment is also envisioned comprising two or more protrusions arranged on the base system which protrude into the disposable cartridge, whereby the monitoring fluid line passes between the protrusions when the disposable cartridge is connected to the base system. The light source and light sensors may then point directly towards the monitoring fluid line, not requiring at least part of the aforementioned reflective surfaces.

Preferably, the second light source is also arranged in the base system, resulting in the same benefits as mentioned above in relation to the positioning of the first light source and the light sensors. The second light source may also be positioned on a protrusion in the aforementioned envisioned alternative embodiment.

Preferably the sensing unit comprises a second light source, wherein the sensing unit is arranged to determine the alignment of the monitoring fluid line based on the light received by the second light sensor from the first light source and the light received by the first light sensor from the second light source.

This provides an additional signal to determine the correct positioning of the disposable cartridge. In addition, this provides a self-test mode to ensure the correct operation of the light source(s) and light sensors.

Preferably, the system, or a generic system, is arranged for detecting pressure in fluid lines, i.e. a fluidic circuit, in a pressure detection unit that is arranged downstream of the microvesicle generating unit. Therefore it is preferred that the pressure detection unit comprises a pressure detection point that is arranged in the system, in particular in the disposable cartridge, comprising a bellow type member that expands under increasing fluid pressure in the disposable cartridge, wherein the pressure detection unit comprises a displacement and/or force sensor that is arranged at a corresponding location, in particular on the base system, wherein said displacement and/or force sensor is arranged for detecting an expansion of the bellow type member. In other words, the base system comprises a force sensor arranged for measuring a force proportional to the fluid pressure in the disposable cartridge. Preferably, the operational controller is arranged for receiving a detection signal from the pressure detection unit. This allows to monitor the hydraulic conditions in the fluidic circuits, in particular allows to monitor whether the microvesicle generation occurs under substantially constant pressure conditions for obtaining microvesicles having a substantially constant size and/or size distribution.

Preferably, the pressure detection unit comprises a force transmission member arranged to transfer a force from the disposable cartridge to a force sensor. This allows the force sensor to be arranged in a more convenient location in the base system. In addition, the force transmission member comprises a flat tip with a predetermined surface area arranged to interact with the pressure detection point. The force transmitted by the force transmission member is then a product of the area of the flat tip and the pressure applied to said flat tip by the pressure detection point.

Preferably, the force transmission member is connected to the base system by one or more resilient members arranged to allow a substantially linear motion of the force transmission member relative to the base system. The resilient members allow for a mounting of the force transmission member without requiring parts that slide past each other. Sliding parts inevitably involve at least some friction which causes at least some hysteresis, which causes an inaccuracy in the measured pressure. The resilient members allow for a hysteresis free mounting of the force transmission member in the base system, allowing for more accurate measurements to be taken.

Preferably, the one or more resilient members comprise linear guidance flexures. The linear guidance flexures are globally ring shaped, whereby the force transmission member is arranged in the center of the linear guidance flexures, and the edges of the flexures are connected to the base system. The linear guidance flexures are each made up of annular folded resilient members extending from the edge of the flexures to the force transmission member. This folding allows for an increased length of the resilient members without increasing the footprint of the linear guidance flexures. The annular, rotationally symmetrical arrangement of these resilient members only substantially allows a linear movement of the force transmission member. The increased length of the resilient members allows for a relatively large range of motion of the force transmission member in the flexures because the spring constant of the resilient members decreases as the length of the resilient members increases.

Preferably, the force transmission member comprises biasing means, wherein the biasing means is arranged to transfer a force applied to the force transmission member to the force sensor. The biasing means functions as a buffer between the force applied to the force transmission member and the force transmitted to the force sensor. This allows the biasing means to absorb an accidental impact on the force transmission member, preventing damage to the force sensor.

Preferably, the biasing means is arranged under a preload, wherein the biasing means is arranged to compress once the force applied to said biasing means exceeds said preload force. Preferably, the preload force is set sufficiently high to allow the full range of forces applied to the force transmission member under normal operation to be fully transmitted to the force sensor. In other words, the preload force is set above the maximum force experienced by the force transmission member as a result of the pressure in the disposable cartridge under normal operating conditions. If this threshold preload force is exceeded, for example due to an accidental impact on the force transmission member during installation of the cartridge, the excess force is at least partially absorbed by the biasing means, preventing damage to the force sensor.

Preferably, a compression of the biasing means compresses the force transmission member, wherein the force transmission member is arranged to contact a rigid end stop as the biasing means compresses. Any force applied to the force transmission member above the threshold preload in the biasing means is then transmitted to the rigid end stop, rather than the force sensor. This allows for a more effective prevention of damage to the force sensor, as also a prolonged excess force is diverted away from the force sensor into the rigid end stop.

Preferably, the force transmission member comprises a cavity and a plunger, wherein the biasing means is at least partially arranged in the cavity, and wherein the plunger is at least partially arranged in the cavity and retained by the cavity, wherein the plunger is arranged to slide into the cavity thereby compressing the biasing means, wherein the plunger is arranged to contact the force sensor, wherein a force applied to the force transmission member is transmitted through the force transmission member, the biasing means and the plunger to the force sensor.

This allows for a compact construction of the force transmission member. In addition, the biasing means is retained in the cavity by the plunger, which is also retained in the cavity. The retention of the biasing means by the plunger allows for a preload force to be applied to the plunger, allowing for the aforementioned force threshold. In addition, the force transmission member, biasing means and plunger are self-contained, requiring no external support to for example retain the biasing means.

In a second aspect, the invention relates to a disposable cartridge for a system according to the preceding embodiments.

In a third aspect, the invention relates to a base system for a system according to the preceding embodiments.

The present invention is further illustrated by the following figures, which show preferred embodiments of the invention and are not intended to limit the scope of the invention in any way, wherein:

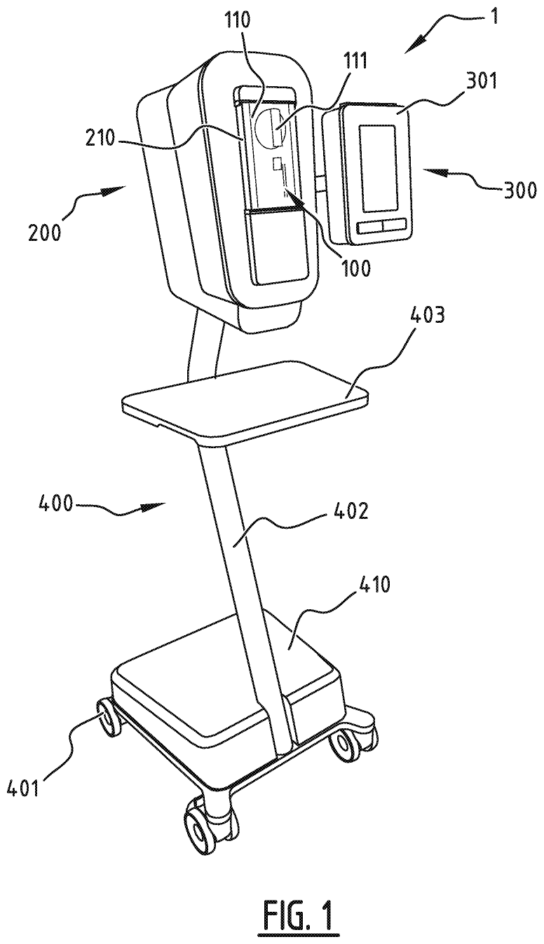

FIG. 1 schematically shows a 3D perspective view of an embodiment of the system for generating microvesicles, in particular microbubbles, having a predefined size and/or size distribution.

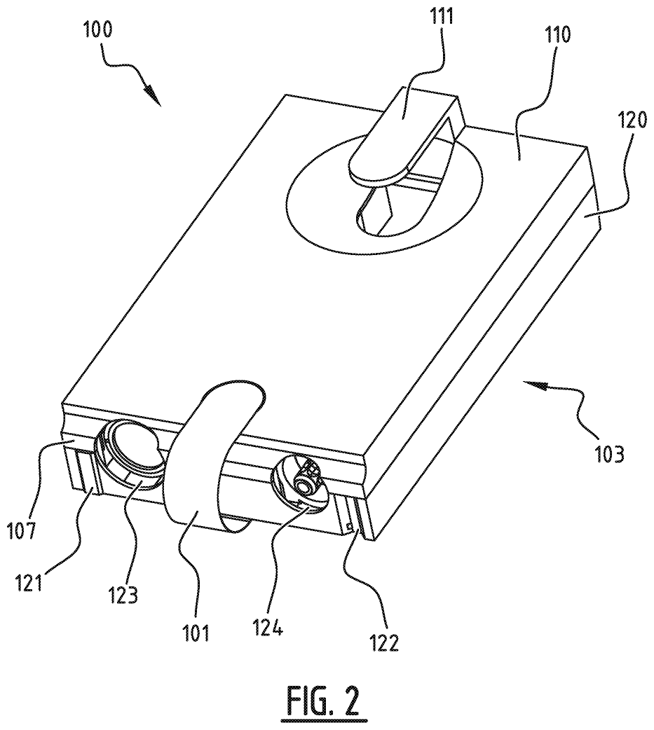

FIG. 2 schematically shows a 3D perspective frontal view of an embodiment of the disposable cartridge, in particular a disposable cartridge as comprised in the system shown in FIG. 1.

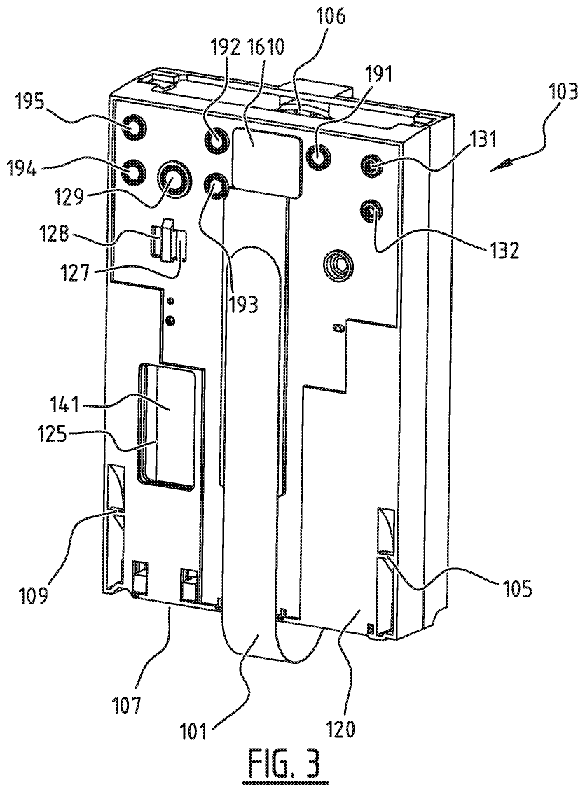

FIG. 3 schematically shows a 3D perspective view of the backside of the embodiment of the disposable cartridge.

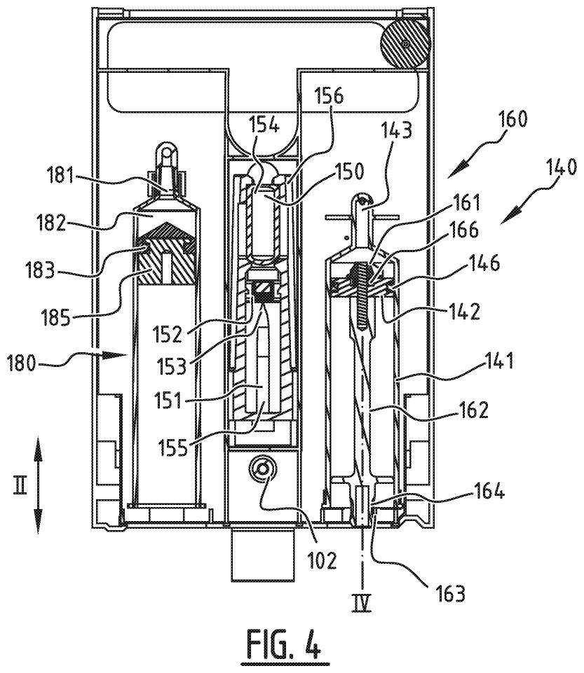

FIG. 4 schematically shows a cross sectional view of the embodiment of the disposable cartridge.

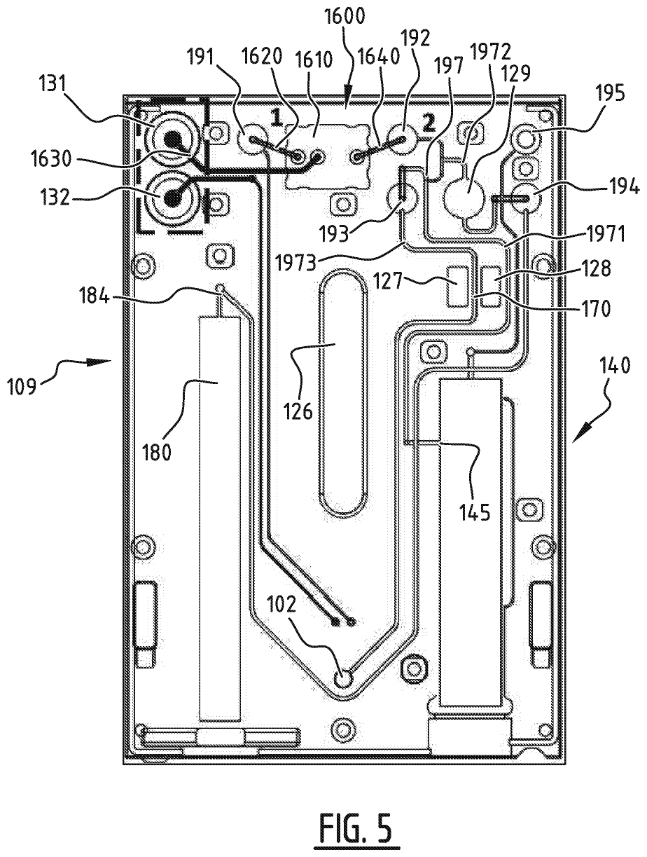

FIG. 5 schematically shows a first functional layout of the fluid channels comprised in an embodiment of the disposable cartridge.

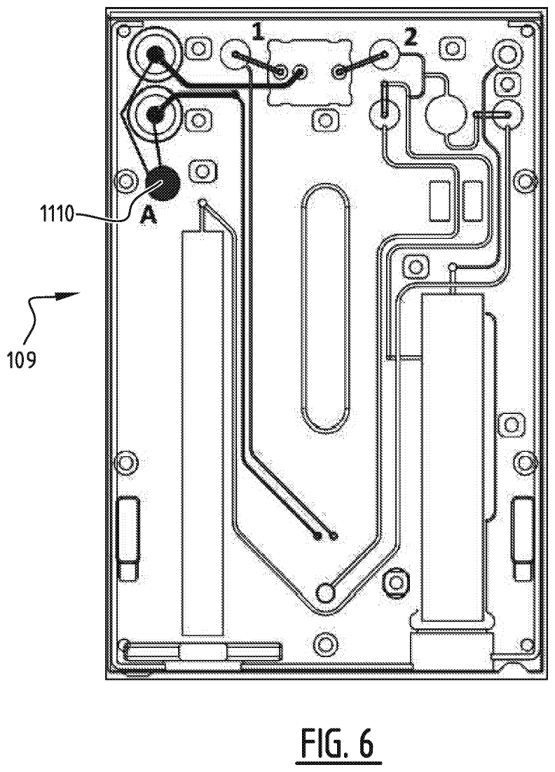

FIG. 6 schematically shows a second functional layout of the fluid channels comprised in an embodiment of the disposable cartridge.

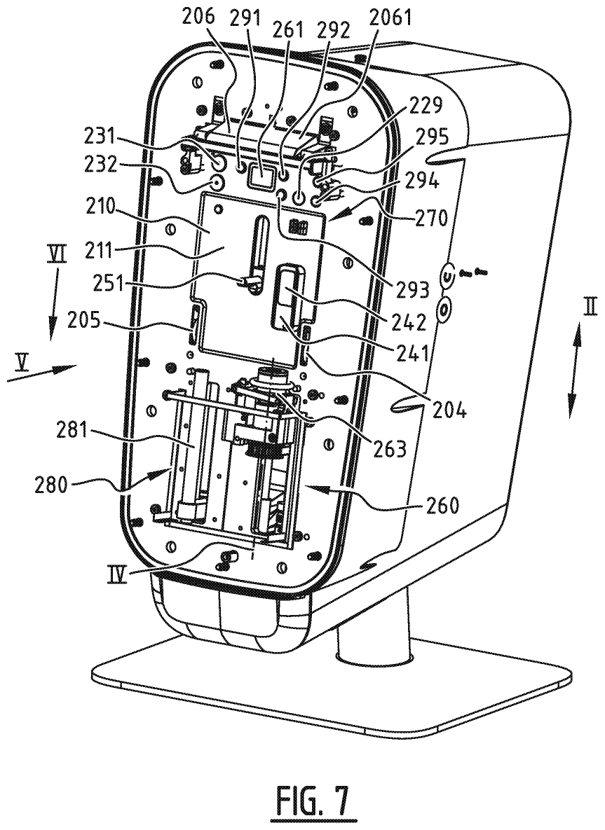

FIG. 7 schematically shows a 3D perspective frontal view of an embodiment of a base system, in particular a base system as comprised in the system shown in FIG. 1, wherein said base system is partially cut-away.

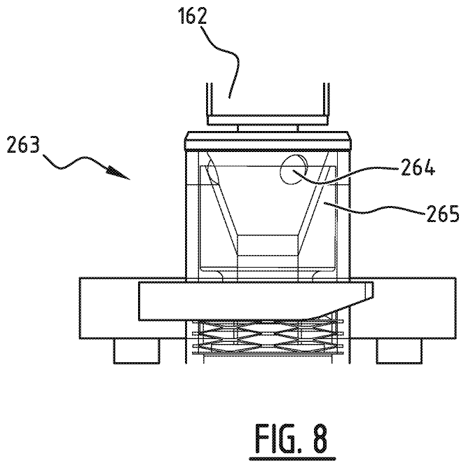

FIG. 8 schematically shows a in frontal, partly transparent view a releasable coupling in more detail.

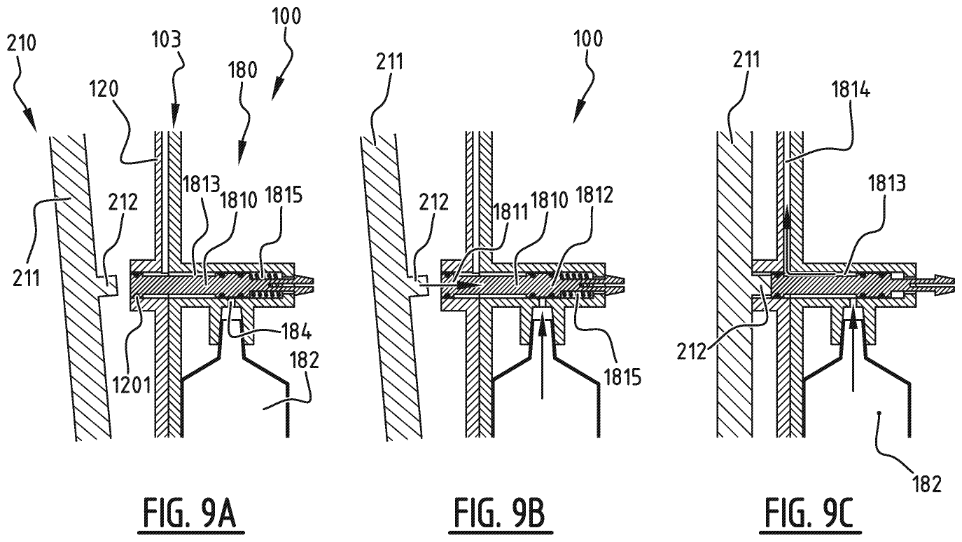

FIGS. 9A-9C schematically show an alternative embodiment of a sealing mechanism for the secondary sealed reservoir as arranged in an embodiment of the disposable cartridge.

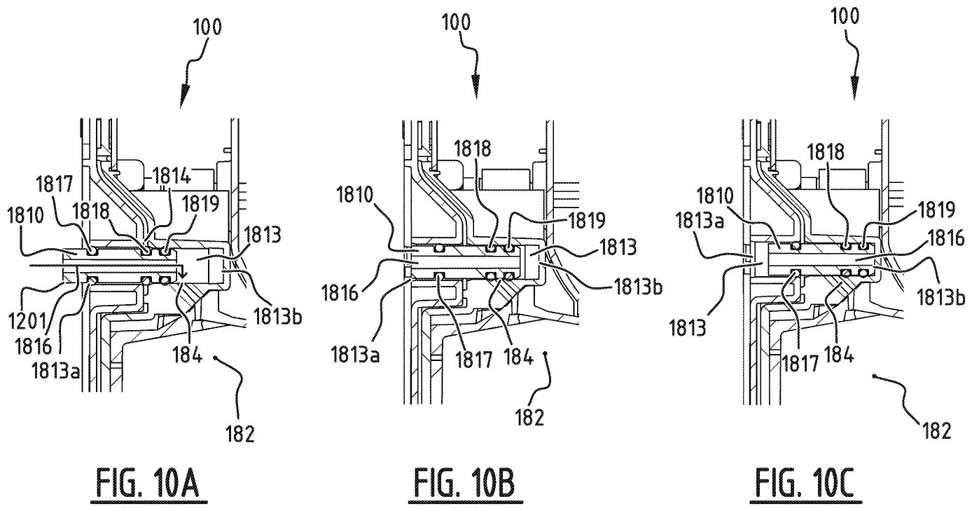

FIGS. 10A-10C show an embodiment of a sealing mechanism for the secondary sealed reservoir as arranged in an embodiment of the disposable cartridge.

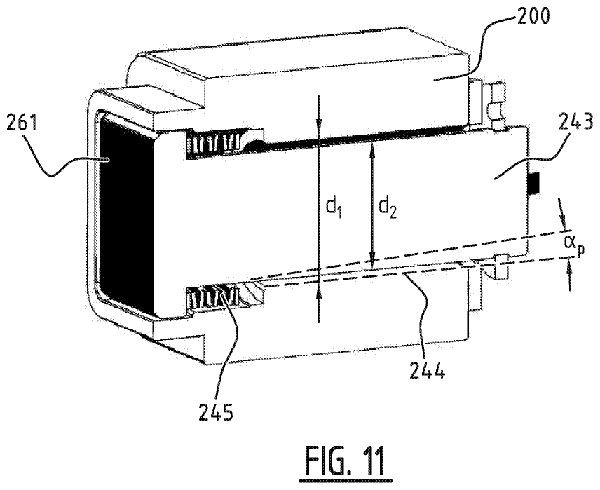

FIG. 11 shows an overview of the heat transfer member.

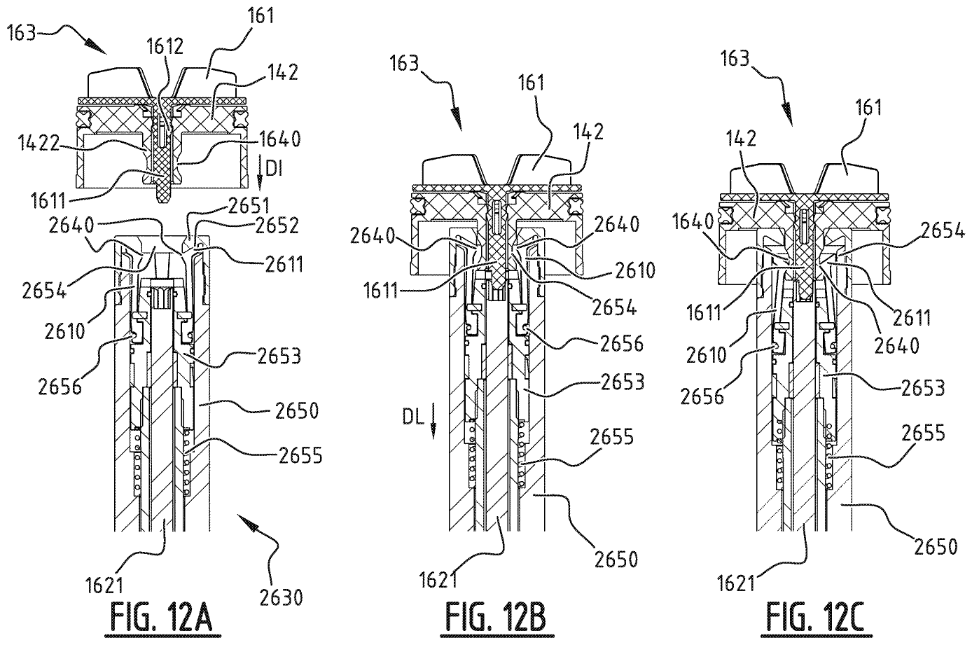

FIGS. 12A-12C show the releasable coupling for coupling the movable piston member and mixing member to the uniformization drive unit.

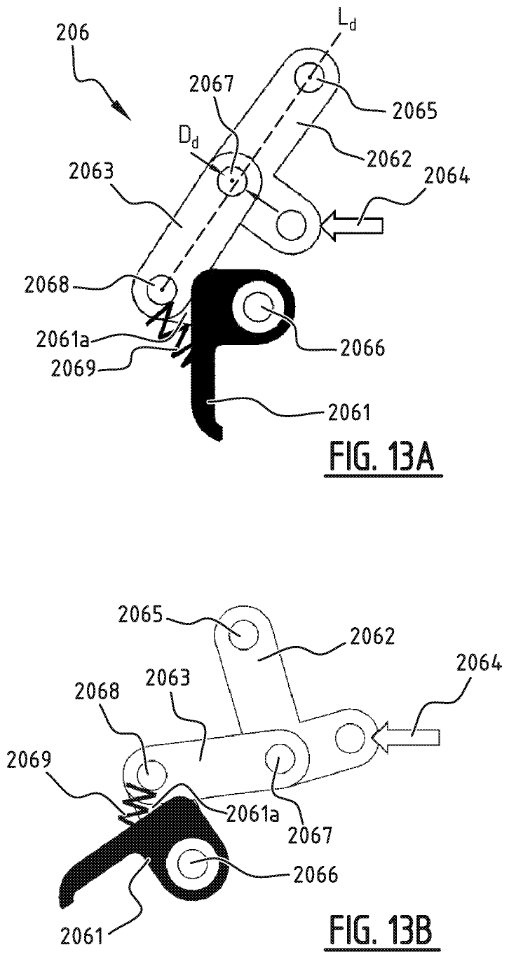

FIG. 13A, B show a schematic overview of the clamping mechanism.

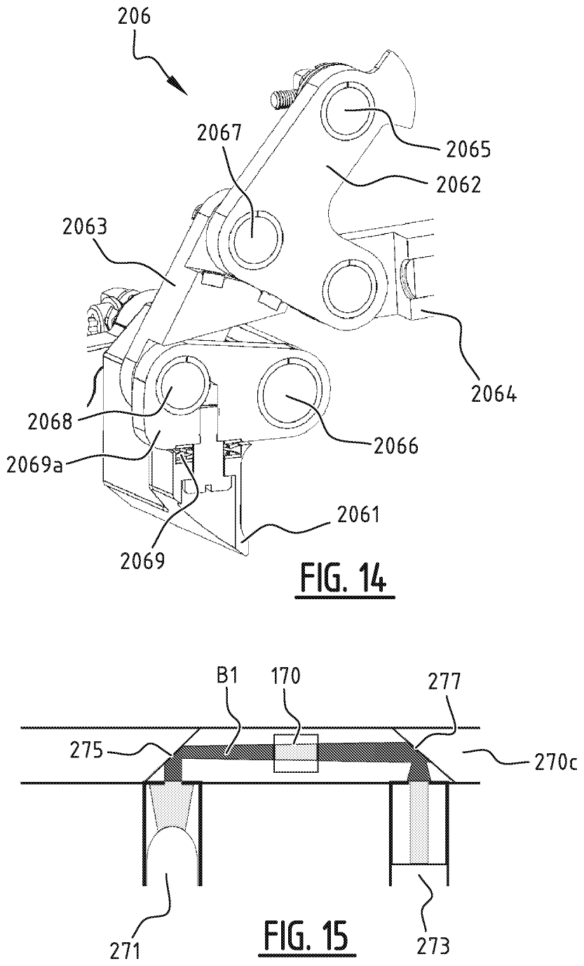

FIG. 14 shows a more detailed view of the clamping mechanism.

FIG. 15 shows a schematic overview of the sensing unit.

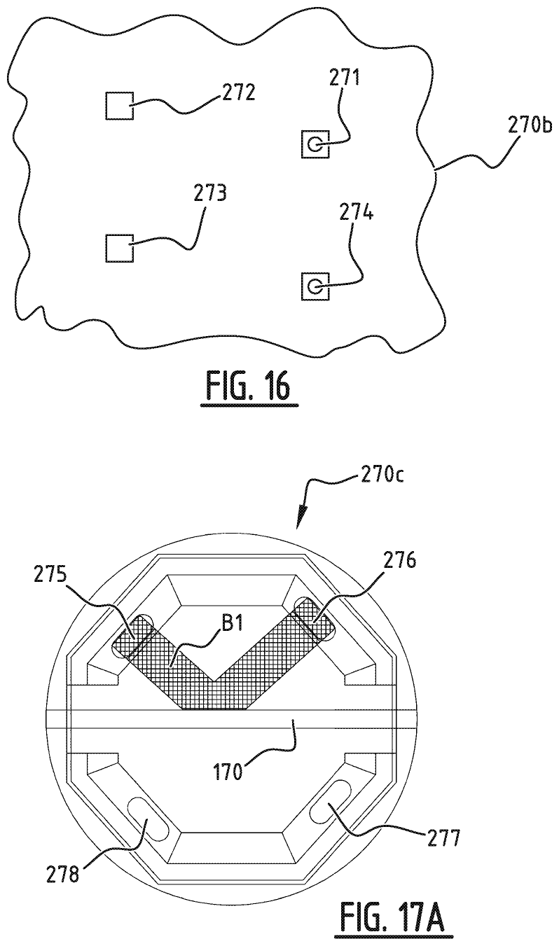

FIG. 16 shows a schematic overview of the part of the sensing unit arranged on the base system.

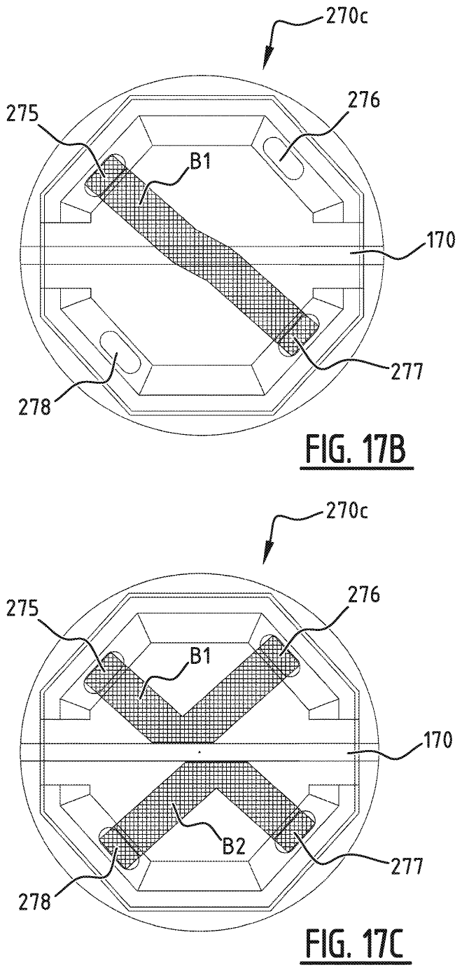

FIGS. 17A-17C show an overview of the part of the sensing unit arranged in the disposable cartridge.

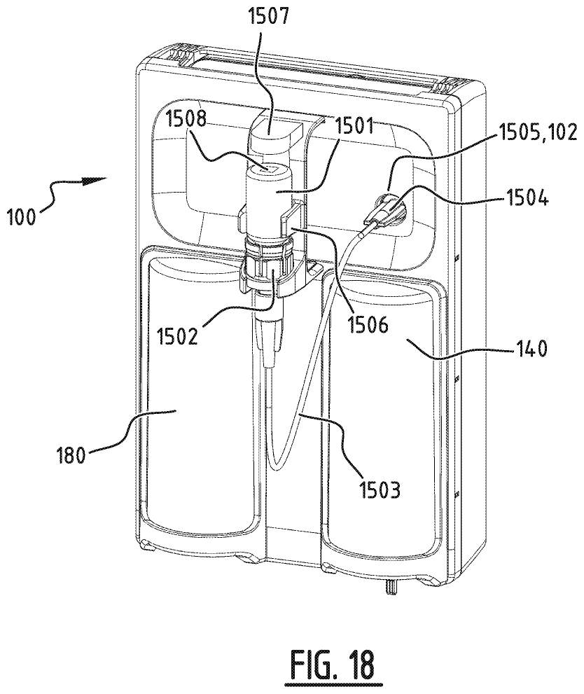

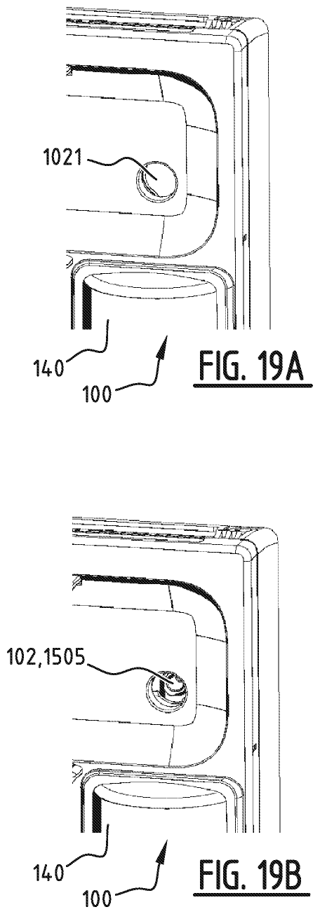

FIG. 18 shows an embodiment of the disposable cartridge where use is made of an external microvesicle suspension.

FIGS. 19A, 19B show the cartridge connector shield.

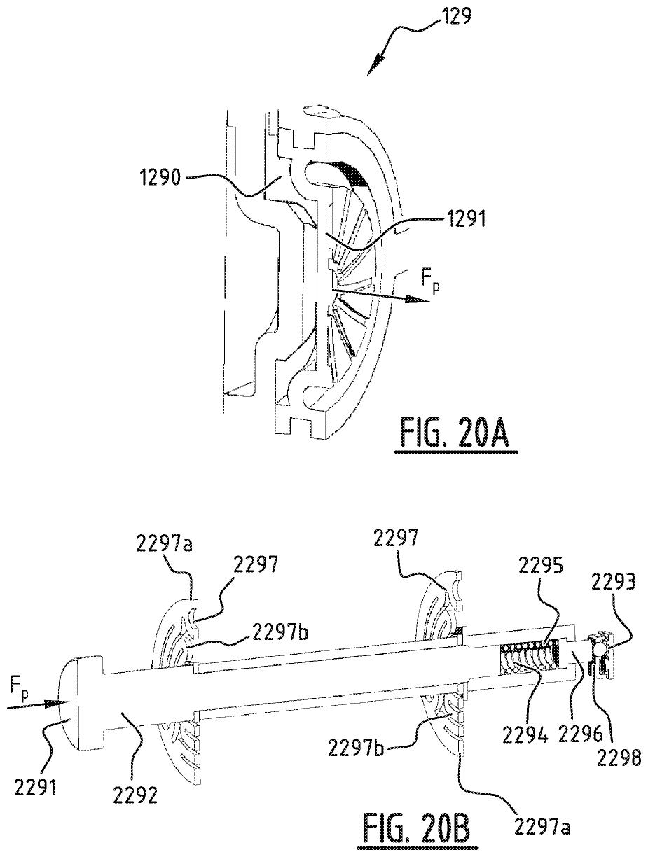

FIGS. 20A, 20B show the parts making up the pressure detection unit.

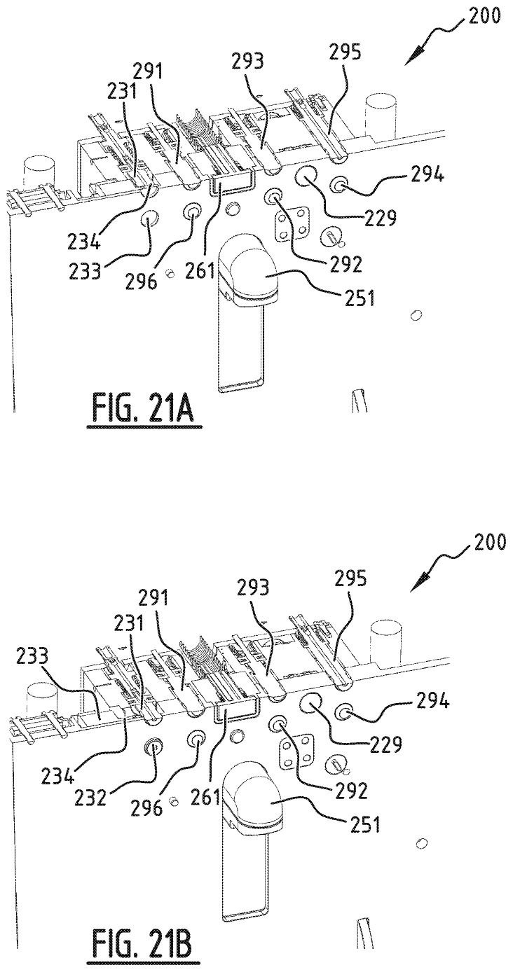

FIGS. 21A, 21B show the movable outlet shield on the base unit.

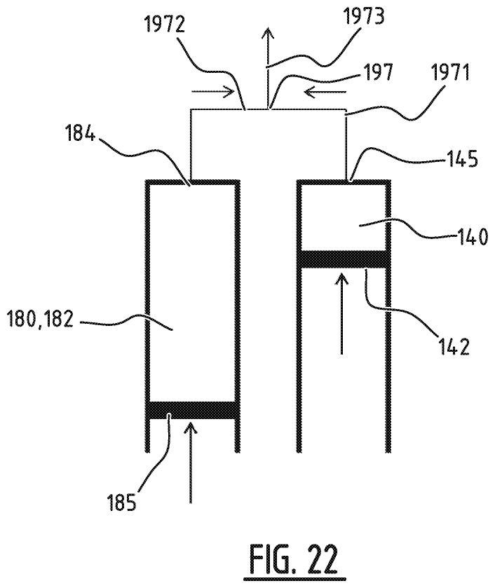

FIG. 22 shows a schematic overview of the mixing unit.

FIG. 1 schematically shows a 3D perspective view of an embodiment of the system 1 for generating microvesicles having a predefined size and/or size distribution. It is noted that the current example is arranged for generating microvesicles having a predefined size and/or size distribution, it would also be suitable for generating, in more general sense, microvesicles having a predefined size and/or size distribution. The system 1 is shown to comprise a base system, hereafter referred to as base station 200 and a disposable cartridge 100 that is arranged a cartridge receiving section 210 of the base station. The cartridge 100 is seen to comprise, in its frontal cover 110, a handle 111, for an improved gripping and handling of said cartridge 100, and to comprise a outer sealing member 101 (see FIG. 2) for sealing the connector 102 (FIG. 4) and for sealing a portion the back cover 120 (FIG. 3) of the cartridge 100. It is noted that said outer sealing member 101, although it is shown as a single outer sealing member 101, may also comprise a number of separate outer sealing members (not shown).

The system 1 comprises an input control unit 300 allowing a user to set respective parameters and systems controls that are used for operating the system 1. The input control unit 300 may comprise buttons, switches, knobs, etc. for setting the respective parameters and/or may comprise a display unit 301 for displaying the respective parameters and/or system state. The display unit 301 may further comprise a touch-sensitive display for displaying a graphic interface unit on said touch-sensitive display. There may further be arranged a movable supporting trolley 400 comprising a set of wheels 401, a trolley supporting member 402 for keeping the base system 200, cartridge 100 and input control unit 300 at an ergonomic working height. A worktop 403 may further be provided on the trolley supporting member 402 for providing a small work bench for the operator. In the housing section 410 of the movable supporting trolley pressurized gas sources in to form of pressurized gas containers may be provided. By combining this with an electric battery unit (not shown), the system may be operated wirelessly (i.e. as a self-supporting system), such that it is easily moved and can be used at locations without power sources.

The cartridge 100, in various embodiments, is shown in more details in FIGS. 2-6. The back cover 120 is shown to comprise a protrusion 121 and recess 122 that are arranged on opposing sides of the lower side 107 of the cartridge 100 with respect to each other. The frontal cover 110 and back cover 120 are part of the housing 103 of said cartridge 100. The cartridge receiving section 210 of the base station 200 comprises respective corresponding negative shapes of said protrusion 121 and recess 122, i.e. respectively a correspondingly shaped recess and correspondingly shaped protrusion, such that the cartridge 100 can only be received by the base station 200 in said cartridge receiving section 210 in a unique position and orientation to properly align the different features, or subsystems, of the cartridge 100 with the corresponding features, or subsystems, of the base station 200. The back-cover 120 is in particular arranged for abutting a back-plate 211 of the receiving section 210. The housing 103 is seen to comprise lower holes 123 and 124 that are arranged through the lower side 107 thereof. These lower holes 123, 124, as is discussed later, are arranged for coupling the respective driving mechanism that drive the various subsystems arranged in the disposable cartridge 100.

Various holes, i.e. openings, 125, 126, 127, 128 gas inlets 131, 132 and other features (which are discussed in more detail below), are seen to have been arranged in/through the back cover 120 of the housing 103. These holes 125, 126-, gas inlets 131, 132 and other features allow the various (parts of the) subsystems arranged in the disposable cartridge 100 to cooperate with the various (parts of the) subsystems arranged in the base station 200.

Firstly, primary and secondary gas inlets 131, 132 are provided for coupling the internal fluidic system of the cartridge 100 with a primary pressure regulation gaseous medium source that originates from the base station 200. The inlets 131, 132 are, in the current example, fixedly arranged in the cartridge 100 and are arranged to engage with nozzles 231, 232 that are arranged in the base station 200. The nozzles 231, 232 are movable along a direction (as seen in the connected state as shown in FIG. 1) towards and from the disposable cartridge 100 and comprise biasing means for urging said nozzles 231, 232 towards the cartridge 100. The inlets 131, 132 are hereby arranged to abut and form a gas-tight connection with the cooperating gas outlets, i.e. nozzles 231, 232, that are arranged in the base station 200 and can be brought in to fluid connection with the respective pressure regulation gaseous medium sources. Preferably, sterile filtering elements having pore sizes of 0.22 μm or less, are arranged in between said inlets 131, 132 and said outlets 231, 232, for preventing any contamination from entering the cartridge. The sterile filtering elements can be arranged in the cartridge 100, the base station 200, or both. It is noted that the second rotating clamping member 206 in FIG. 7 is arranged for pressing the cartridge comprising gas inlets 131, 132 towards the nozzles 231, 232, such that the respective biasing means, such as springs, elastic elements, or pneumatic cylinders, are compressed, thereby generating the required preload for obtaining the gas-tight interface.

The various holes 125, 126, 127, 128 of the current example serve different purposes. It is noted however, that the hereafter described functionalities are not intrinsically linked to said holes 125, 126, 127, 128, as alternatives for holes in a housing 103 are imaginable. The first through hole 125 is arranged in the back cover 120 to allow for a holding unit heat transfer element 241 that is arranged in base station 200 to protrude through the back cover 120 and abut, with an active heating/cooling surface 242 thereof, a storage container 141 of the holding unit 140, which is discussed in more detail below. The holding unit heat transfer element 241 allows to rapidly heat and/or cool the contents, i.e. the heterogeneous mixture comprising the generated microvesicles and the microvesicle carrier liquid, of the holding, i.e. storage, container 141 of the holding unit 140. The holding unit 140 is further shown to comprise a movable piston member 142, comprising a slidable seal 146 that abuts in inner wall of the holding container 141, that encloses, with holding container 141, an interior volume 143 for holding said microvesicle containing heterogeneous mixture and wherein said movable piston member 142 is movable in the holding container 141 for increasing or decreasing the internal volume 143, such that the said microvesicle containing heterogeneous mixture can be diluted, by adding the microvesicle carrier liquid to the heterogeneous mixture comprising the generated microvesicles in the holding container 141, and/or expelled from the holding container 141. In the current example, the movable piston member 142 is arranged to be driven, in an up-and down direction II.

A uniformization mechanism 160 is arranged with the movable piston member 142 and comprises a rotatable mixing element 161 that extends, from the movable piston member 142 into the holding unit 140, in particular into the internal volume 143. The rotatable mixing element 161 comprises a plurality of fins that extend inside said interior volume 143, and is arranged to rotate with respect to the movable piston member 142, as they are connected by means of rotational bearing 166. To allow to drive the movable piston member 142 and rotatable mixing element 161 a shared shaft 162 is provided having a releasable coupling 163 at its bottom. The shared shaft 162 is thereby at least rotatably connected to the rotatable mixing element 161 and translationally connected to the movable piston member 142.

The releasable coupling 163 is, as is also shown in FIG. 8, arranged to be received in cooperating coupling sleeve 263 of the rotational and translational driving mechanism 260 that is arranged in the base station 200. The releasable coupling 163 comprises for the purpose a plurality of recesses, or dimples, 164 arranged in an outer wall of the releasable coupling 163. The cooperating coupling sleeve 263 comprises a number of movable protrusions, in particular ball members, that are arranged to move in a radial outwardly direction with respect to a central axis of IV of the cooperating coupling sleeve 263 for moving said sleeve 263 over the releasable coupling 163, after which the movable protrusions 264 are arranged to move inwardly in order to be received in the plurality of recesses, or dimples, 164. Said movable protrusions can then be locked in position, for instance by restricting the outward radial movement by providing a locking ring 265 around the movable protrusions 264, thereby obtaining a coupling between the shared shaft 162 and the rotational and translational driving mechanism 260. The rotational and translational driving mechanism 260 is arranged for rotationally driving the cooperating coupling sleeve 263, and thereby the rotatable mixing element 161, around the central axis IV and arranged for translationally driving the cooperating coupling sleeve 263, and thereby the movable piston member 142 with the rotatable mixing element 161 along a translational up and down direction II. The sleeve 263 is arranged to protrude through the second lower hole 124 in order to couple to the shared shaft 162.

As an in/outlet 145 of the holding unit 140 can be in fluid connection with the connector 102, which is a luer type connection in the current example, to which an infusion line can be coupled, the heterogeneous mixture comprised in the internal volume 143 can be directly administered to a subject receiving treatment. By moving the movable piston member 142 upwardly along the direction II, the interior volume 143 is decreased, such that the therein held heterogeneous mixture is pushed through the in/outlet 145 towards the connector and towards the subject.

The current example also comprises a second through hole 126, that is covered by the outer sealing member 101, which is arranged for receiving a movable pushing member 251 (FIG. 7). The movable pushing member 251 is arranged to push, in the initialization state, a sealed reservoir, i.e. container, 150 (FIG. 4), which is in the current example an upside down arranged sealed off vial, towards a seal opening spike 151 that is arranged to puncture the seal 152 with which the sealed reservoir is closed off. The sealed container 150 is held, in the current example, in an elastic suspension member 156, preventing an accidental unsealing of the container 150, as a predefined urging force is required to move the sealed container 150 from the elastic suspension member 156. The movable pushing member 251, which is arranged to move linearly in an up-and down direction II, is also arranged for pushing sealed reservoir 150 such that the tip 153 of the spike 151 is arranged to end up in an upper region 154, i.e. close to the bottom of the vial. A pair of in/outlets is arranged with the spike 151, the first in/outlet is arranged in, or near the tip 153, allowing pressurized gas to be inserted in the reservoir 150, the second in/outlet is arranged near a bottom 155 of the spike 151, allowing the second fluid, in this example a liposome solution, that is held in the reservoir 150 to be pushed from the reservoir to the microvesicle generation unit 1600, which is discussed below.

A sensing unit 270 is provided on the base station 200, wherein the sensing unit 270 is, in the current example, arranged to protrude through sensing holes 127, 128 in order to monitor the fluid passing through a monitoring fluid line 170 that is arranged in between said holes 127, 128. The sensing unit 270 is arranged to detect a translucence of the fluid, in particular the fluid coming from the holding unit 140, passing the monitoring fluid line and thereby detect whether the heterogeneous mixture comprising microvesicles passes the line, or whether a single phase liquid or gas passes, at which point the operational controller can, for instance, detect that the system 1 malfunctions, or that the fluid is not yet suitable to be introduced in the circulatory system of the subject. The sensing unit 270 is thereby also able to detect the presence of gas in the fluid lines, or (large) pockets of gas present in the fluid, such that it can be prevented that these are introduced in the circulatory system of the subject, as was also described above.

The disposable cartridge 100 further comprises a secondary sealed reservoir 180 containing the microvesicle carrier liquid, in particular a saline solution, wherein, in the initialization phase, the secondary sealed reservoir is arranged to be opened and arranged to be in fluid communication with the holding unit 140. The secondary sealed reservoir 180 is seen to comprise a movable sealing element 181 that is, before use, arranged to remain in a sealing position wherein the movable sealing element 181 seals the secondary sealed reservoir 180 and that, when in the initialization phase, is moved to an opening position, whereby the secondary reservoir 180 can be brought in fluid communication with the holding unit 140.

The secondary sealed reservoir 180 is seen to comprise a second movable piston member 185 that comprises a slidable sealing element 183 that is arranged between the interior wall of the reservoir 180 and the second movable piston member 185. The second movable piston member 184 is arranged to be movable in the up and down direction II. A second interior volume 182 is thereby defined, by pushing the second movable piston member 185 upwardly using the respective secondary sealed reservoir driving mechanism 280, comprising pushing rod 281 that is arranged to protrude lower hole 123 and to contact and push the second movable piston member 185, the second interior volume 182 is decreased, thereby raising the pressure until the movable sealing element 181 moves upwards above a certain pressure threshold and remains in the upward position, even when the pressure decreases again. As the movable sealing element 181 thereby clears from secondary sealed reservoir outlet 184, the therein held liquid is free to enter the internal channel system 109 of the cartridge 100.

Disposable cartridge 100 comprises, at the respective sides of the back cover 120, a pair of hook-on elements 104, 105 that are arranged to be engaged by rotating clamping members 204, 205 arranged at corresponding locations in the base station 200. The pair of hook-on elements 104, 105, forming a first clamping portion, are urged, by the rotating clamp member 204, 205 in a first clamping direction V towards the base station and urge in a second clamping direction VI that substantially parallel, and downward oriented, to the base station 200, in particular the receiving portion 210, and preferably perpendicular to the first direction V. A second rotating clamping mechanism 206 is provided at the top of the receiving portion 210 and is arranged for engaging an upper side 106 of the frontal cover 110 of the cartridge 100 for urging said upper side 106 in the first clamping direction V.

FIG. 5 schematically shows a first functional layout of the fluid channels system 109, i.e. the fluidic circuit, i.e. the pneumatic and hydraulic circuit, comprised in an embodiment of the disposable cartridge 100. By moving the second movable piston member 185 upwardly, the seal of the secondary sealed reservoir 180 is opened, as was described above and, if the fourth valve 194 is open, and the second and third valves 192, 193 are closed, the microvesicle carrier liquid, e.g. a saline solution, is pushed towards the holding container 141. Pressure in the respective fluid lines is measured at a pressure detection point 129 comprising essentially a bellow type member that expands under pressure. By arranging a displacement and/or force sensor 229 at a corresponding location in the base station, this can be registered by both a safety controller and an operational controller of the base station.

The microvesicle generating unit 1600, comprising the microfluidic chip 1610, is seen to comprise a first microfluidic chip inlet 1630 that is connected to the first gas inlet 131 for providing the first fluid to the micro-fluidic chip 1610, a second micro-fluidic chip inlet 1620 that is in selective fluid connection, by use of first valve 191, with the second in/outlet of the spike 151. The first in/outlet of the spike 151 (that has already opened the sealed container, as was described above) is in fluid connection with the second gas inlet 132, that provides the pressurized gas for pushing the second fluid, when the first valve 191 is opened, towards the microfluidic chip 1610 through the second in/outlet of the spike 151. The respective flows of first and second fluids are mixed in the micro-fluidic chip 1610 to generate microvesicles in a manner known to the skilled person. The generated microvesicles exit the microfluidic chip 1610 through the microfluidic chip outlet 1640 and, if the second valve 192 is opened and the third and fourth valves 193, 194 are closed, are guided towards, and through, the in/outlet 145 of the holding unit 140 into the holding container 141, which comprises the microvesicle carrier liquid originating from the secondary sealed reservoir 180, as was described above. The microvesicles are mixed with the carrier liquid for forming the heterogeneous mixture, as was discussed above. Excess (gas) pressure in the holding container 141 can be vented off through pressure release valve 195. The valves 191-195 can be actuated using valve actuators 291-295 that are at corresponding locations in the base station 200. The microfluidic chip 1610 is arranged to be heated by the (movable; as was described earlier) heat transfer element 261 that is arranged at a corresponding location at the base station 200.

The microfluidic chip 1610 is preferably held in the cartridge in a manner wherein the microfluidic chip may have, in the unconnected state of the cartridge, limited movement with respect to the disposable cartridge 100. For obtaining a fluid-tight seal, at least for the pressures that the gaseous source is arranged to deliver (i.e. typically 6 bar or less), an O-ring (not shown) that is made from an elastomeric or rubber material is arranged between said chip 1610 and said cartridge 100. Upon coupling and locking the cartridge 100 into the base station 200, the chip is urged, using the heat transfer element 261 that is biased in the direction towards the cartridge by a biasing mechanism, towards the cartridge, to the cartridge. The O-ring, i.e. flexible sealing member, is thereby pressed between said chip 1610 and cartridge 100 for obtaining the fluid-tight hydraulic coupling. As was described earlier, internal filter members (not shown) are arranged at the fluid-tight hydraulic coupling in between the fluidic circuit, i.e. fluid channels system 109, of the cartridge 100 and the micro-fluidic chip 1610.

After the microvesicles have been generated and stored in the holding container 141, pressure is released from the cartridge (the pressured gas sources can, for instance, be switched off, disconnected or any pressurized gas in the cartridge can be released into the environment, such that the cartridge is no longer pressurized) and second and fourth valves 192, 194 are closed and third valve 193 is opened, at which state, by moving the movable piston member 142 upwardly, the heterogeneous mixture held in the holding container 141 is urged towards the connector and a connected infusion line, such that, under continuous uniformization by driving the rotatable mixing element 161, the heterogeneous mixture can be directly administered to the subject. Upon removal of the cartridge 100 from the base station 200, any remaining pressurized gas at the inlets 131, 132 will automatically escape.

FIG. 5 additionally shows an embodiment of the mixing unit 197, which is arranged to combine a flow 1972 of microvesicle carrier liquid, preferably saline, from the secondary reservoir 180, and a flow 1971 of fluid, preferably heterogeneous and preferably uniformized microvesicle containing mixture or external microvesicle suspension from the holding unit 140, into a combined flow of fluid 1973. The combined flow 1973 then flows toward the connector 102 and the subject connected to said connector. The geometry of the mixing unit, which comprises a junction of the fluid channels through which the flows 1971 and 1972 flow, has an impact on the mixing of the two fluids. Preferably, a T-junction is used wherein the flows 1971 and 1972 flow towards each other in opposite and preferably substantially parallel directions, and the combined flow exits in a perpendicular direction, is used (shown schematically in FIG. 22).

An alternative embodiment of the system, in particular of base station (not shown), employing the cartridge shown in FIG. 5 comprises a manually operated mode switch that, whereby a pressure relief valve, in particular a 3/2 way valve, is manually opened for releasing the pressurized gas remaining the fluidic circuits of the disposable cartridge. After the pressure is released, the disposable cartridge can be removed from the base station, or the generated microvesicles may be administered to the subject, as was described above.

FIG. 6 schematically shows a second functional layout of the fluid channels system 1109, i.e. the fluidic circuit, i.e. the pneumatic and hydraulic circuit of the cartridge 100. The second layout only differs from the first in that a pressure release valve 1110 is added that is in fluid connection with the first and second gas inlets that enables to release any remaining pressurized gas at the inlets 131, 132 before removal of the cartridge 100 from the base station.

FIGS. 9A-9C schematically show an alternative embodiment of a secondary sealing mechanism comprising an alternative movable sealing element 1810 for the secondary sealed reservoir 180 as arranged in an embodiment of the disposable cartridge 100. In FIG. 9A, the base station 200 and cartridge 100 are in the unconnected state, but are mutually positioned to be brought to the connected state. The base station 200, in particular a back-plate 211 of the cartridge receiving section 210, is seen to comprise a secondary sealing mechanism protruding member 212 that extends from the back-plate 211 in the direction towards the cartridge 100. The cartridge 100, in particular the back cover 120 comprises a mutually cooperating opening 1201 that is arranged for receiving the secondary sealing mechanism protruding member 212. The mutually cooperating opening 1201 extends into alternative movable sealing element holding channel 1813 wherein the alternative movable sealing element 1810 is slidably arranged. The alternative movable sealing element 1810 comprises a blocking-section 1812 arranged for closing, i.e. sealing, the secondary sealed reservoir outlet 184. A secondary sealing biasing mechanism 1815 is arranged for urging the alternative movable sealing element 1810 to the closed position, wherein the blocking-section 1812 closes said outlet 184.

Upon connecting the cartridge 100 and base station 200, as is best seen in FIGS. 9B and 9C, the secondary sealing mechanism protruding member 212 abuts an outer end 1811 of the alternative movable sealing element 1810 for pushing the alternative movable sealing element 1810 against the urging direction, such that the blocking-section 1812 is moved from a closing position to an opened position, thereby allowing fluid held in the second interior volume 182 to be pushed therefrom, through the alternative movable sealing element holding channel 1813 to a respective channel 1814 of the cartridge 100. Thereby allowing the microvesicle carrier liquid held therein to be pushed to the holding container 141, as was described above.

FIGS. 10A-C show another alternative embodiment of a secondary sealing mechanism, comprising an alternative movable sealing element 1810 comprising a through hole 1816. The shown embodiment allows the secondary sealing element 1810 to have three distinct positions in the sealing element holding channel 1813. The secondary sealing element 1810 comprises three seals, a first seal 1817, a second seal 1818 and a third seal 1819, all three are preferably O-ring seals. A first position is shown in FIG. 10A, which is the filling position. In the filling position, all three seals 1817-1819 are on one side of the secondary sealed reservoir outlet 184, on the side closest to the opening of the sealing element holding channel 1813a. Hereby a channel is formed from the outside of the cartridge, through the through hole 1816 in the secondary sealing element towards the secondary sealed reservoir outlet 184. In the filling position, fluid can be added to the secondary sealed reservoir 182 to fill it. A second position is shown in FIG. 10B, which is the sealing or closed position. The same sealing principle is used as is shown in FIG. 9A, where the second seal 1818 and third seal 1819 are positioned on opposing sides of the secondary sealed reservoir outlet 184, thereby sealing it. A third position is shown in FIG. 10C, which is the unsealed or open position, again the same principle is applied as in FIG. 9C. The first seal 1817 and second seal 1818 are positioned on opposing sides of the secondary sealed reservoir outlet 184. As the diameter of the movable sealing element 1810 is smaller than the diameter of the sealing element holding channel 1813 at least between the first and second seals 1817, 1818, a passage is formed from the secondary sealed reservoir outlet 184, through the sealing element holding channel 1813 and around the movable sealing element 1810 towards the channel 1814 in the cartridge 100.

FIG. 11 shows the heat transfer element assembly 261 in more detail. The heat transfer element 261 comprises a heating/cooling surface 261 and a heat transfer element shaft portion 243 which is slidably arranged in the guide section 244. A biasing element 245 provides a biasing force to push the heat transfer element 261 outwards towards the location of the disposable cartridge. The shaft portion 243 comprises a cylindrical member with a circular cross section with diameter d₂, and the guide section 244 comprises a tubular section with a circular cross section with diameter d₁. The diameter d₂ is smaller than diameter d₁, which allows a degree of play between the heat transfer element shaft 243 and the guide section 244. This play allows a limited rotation and translation of the heat transfer element shaft 243 around the two axes perpendicular, or orthogonal to the centre axis of the heat transfer element shaft 243. These additional degrees of freedom allow the heating/cooling surface to shift position to optimally contact the disposable cartridge, in particular the microfluidic chip. One of the degrees of freedom of the heat transfer element is indicated by angle ap, which is preferably approximately 1.5°. Preferably, a similar degree of play is allowed in the orthogonal direction. A degree of rotation around the axis parallel to the centre axis of the heat transfer element shaft 243 may also be possible.

FIGS. 12A-C show an alternative embodiment of the releasable coupling 163. The coupling 163 comprises an outer locking sleeve 2650 which encloses the inner locking sleeve 2653, enclosing the mixing drive shaft 1621. The coupling 163 additionally comprises a plurality of movable coupling members 2610, which are partially retained between the inner locking sleeve 2653 and the outer locking sleeve 2650 and move with the inner locking sleeve 2653. The movable coupling members 2610 comprise a cam portion 2611 and a protrusion 2640 arranged to interact with a corresponding groove 1640 on the piston member 142. A cap 2651 is additionally arranged on the end of the outer locking sleeve 2650, against which the piston member 142 is pulled when the piston member 142 is coupled to the coupling 163. A gap is present between the end of the outer locking sleeve 2650 and the opposing underside of the cap 2652. Said gap provides room for the movable locking members 2610 to move into when the releasable coupling 163 is in the open position. In FIG. 12A the cam portions 2611 of the movable locking members 2610 are shown in said gap. The coupling comprises a coupled state (FIG. 12C) and a released state (FIG. 12A, B). In the released state, the inner locking sleeve 2653 is moved towards the cap 2651, moving the coupling members 2610 with it. The cam portions 2611 are guided by the underside of the cap 2652 into the gap between said underside and the end of the outer locking sleeve 2650. The cam portions 2611, as well as the protrusions 2640 are thereby moved outwards from the centre axis of either locking sleeve. The coupling portion 1422 of the piston member 142 may then be inserted into the coupling 163 through a hole 2654 in the cap 2651. To couple the piston member 142 to the coupling 163, the inner locking sleeve 2653, together with the coupling members 2610 moves away from the cap 2651 in direction DL, shown in FIG. 12B, C. The cam portions 2611 then engage the end of the outer locking sleeve 2650 and are pushed inwards, moving the top parts of the coupling members 2610 and the protrusions 2640 inwards and away from the cap 2651. Hereby the protrusions 2640 may engage the groove 1640 on the coupling portion 1421 of the piston member 142, pulling it towards the cap 2651 and retaining it. A biasing means 2655, preferably comprising a spring, is arranged below the inner sleeve 2653, which is supported on its underside by a ridge on the inner surface of the outer sleeve 2650. This biasing means 2655 biases the inner sleeve 2653 upwards towards the open position to improve the process of disconnecting the piston member 142 from the releasable coupling 163. An additional biasing means 2656 is arranged around the movable coupling members 2610, at the lower portions of said movable coupling members 2610. This biasing means preferably comprises a ring such as an O-ring. The biasing means 2656 pulls the lower portions of the movable coupling members 2610 inwards, which results in a biasing force towards the outside at the top parts of the movable coupling members 2610. This provided an additional force that pushes the movable coupling members 2610 towards the open state when the releasable coupling is opened when the inner sleeve 2653 and the movable coupling members 2610 are moved upwards.

The mixing element 161 comprises a drive stalk 1611 which is arranged to be inserted through and be rotatably retained (meaning that a rotational movement is allowed) in the hole 1422 in the piston member 142. When the piston member 142 is connected to the coupling 163, the drive stalk 1611 connects to the mixing drive shaft 1621 to allow the mixing drive shaft 1621 to transmit a rotating motion to the mixing element 161. The drive stalk 1611 comprises a plurality of flexible protrusions 1612 to allow it to snap into a narrower portion of the hole 1422 in the piston member 142 to retain the mixing element 161 in the piston member 142.

FIG. 13A, B show a schematic overview of an embodiment of the rotatable clamping mechanism 206. The rotatable clamping mechanism is shown in the closed position in FIG. 13A and in the open position in FIG. 13B. The clamping mechanism 206 comprises a rotating clamp 2061 which is rotatably connected to the base station 200 (not shown) with second pivot 2066. An L-shaped rotating member 2062 is rotatably connected to the base station 200 (not shown) with a first pivot 2065, and a linkage 2063 connects the rotating member 2062 and the clamp 2061. The linkage 2063 connects to the first hinge 2067 and the second hinge 2068 are offset from respectively the first pivot 2065 and the second pivot 2066. A rotation of the rotating member 2062 is transferred to the clamp 2061 by the linkage 2063, rotating the clamp 2061 in a direction opposite to the direction of rotation of the rotating member 2062. A line drawn between the first pivot 2065 and the second hinge 2068 defines the dead point line Ld, as shown in FIG. 13A. The dead point occurs when the first hinge 2067 lays on the dead point line Ld. In this dead point state, a force acting on the clamp 2061 is transferred by the clamp in a direction pointing through the centre of the first pivot 2065. This transferred force therefore does not have a moment arm around the first pivot 2065, preventing the force from rotating the rotating member 2062 to release the clamp. In the closed state, shown in FIG. 13A, the centre of the hinge 2067 lies beyond the dead point line Ld, at a distance indicated by Dd. The clamp 2061 comprises two parts, the main clamp 2061 and the clamp lever 2061a, which are rotatably connected by the second pivot 2066. The linkage 2063 connects to the clamp lever 2061a in the second hinge 2068. A biasing means, preferably a flexible member such as a spring 2069 is arranged between the clamp lever 2061a and the main clamp 2061 such that a rotation of the clamp lever 2061a is transferred to the main clamp 2061 only through the biasing means 2069. This allows the clamping mechanism 206 to rotate through the dead point without forcing the main clamp 2061 further into the cartridge 100 beyond the position the clamp 2061 would be in in the closed position. The rotation of the clamp lever 2061a beyond the position it would be in in the closed position is absorbed by the biasing means 2069, preventing an excessive force from being applied to the cartridge 100 by the main clamp 2061.

FIG. 14 shows a cross section of the embodiment of the rotatable clamping mechanism 206 in the locked state. The locking drive mechanism comprises an actuator 2064 arranged to push against the rotating member 2062 to rotate it, and therefore to rotate the clamp 2061 between the locked and the released state. The actuator 2064 extends to move the rotating member 2062 towards the locked state. In the locked state, the clamping mechanism 206 is moved through the dead point, meaning that a force acting against the clamp is transferred to pull on the actuator 2064. As the actuator cannot extend beyond the position it is in in the locked state, as the clamping mechanism 206 moves towards an end stop in the locked position, said force cannot cause the clamp 2061 to rotate from the locked state to the released state.

FIG. 15 shows a schematic side view of a preferred embodiment of the sensing unit 270, more specifically the parts arranged in the base system 200. The sensing unit 270 comprises two interacting parts 270b and 270c respectively arranged at corresponding locations on the base system 200 and the disposable cartridge 100. The base unit part of the sensing unit 270b comprises a first light source 271, such as an LED, as well as two light sensors 272, 273. Preferably, the base unit part of the sensing unit additionally comprises a second light source 274. The light sources 271, 274 and light sensors 272, 273 are oriented to emit or receive light towards and from the location of the disposable cartridge 100.

FIG. 16 shows a view of the base system part of the sensing unit 270b, seen in a direction towards the base system 200. The two light sources 271, 274 are arranged to project light out of the base system 200 towards the location of the disposable cartridge 100. The two light sensors 272, 273 are similarly arranged towards the outside of the base system to receive light from the direction of the disposable cartridge 100.

FIG. 17A shows a view of the cartridge part of the sensing unit 270c, seen in a direction towards the disposable cartridge 100. The cartridge part of the sensing unit 270c comprises four reflective surfaces 275-278 arranged around a monitoring fluid line 170. The reflective surfaces 275-278 may comprise any reflective material, for example mirrors or reflective pieces of plastic. The reflective surfaces 275-278 may be comprised by the same material the case of the disposable cartridge 100 is constructed out of. The reflective surfaces 275 and 278 are oriented to correspond to the locations of the light sources 271, 274 when the cartridge is mounted on the base system 200. The reflective surfaces 275 and 278 are arranged at an angle to reflect received light towards the monitoring fluid line 170. In FIG. 17A the reflective surface 275 reflects light received from light source 271 in a beam B1 towards the monitoring fluid line 170, and the beam B1 is reflected by the monitoring fluid line 170. This reflection occurs when there is no liquid present in the monitoring fluid line 170, or when there is locally no liquid present due to a pocket of gas in the monitoring fluid line 170 at the point where the beam B1 is projected on the monitoring fluid line 170, resulting in a refractive index that causes the beam B1 to be reflected, towards the reflective surface 276. The reflective surface 276 corresponds to the location of the light sensor 272 and is arranged to reflect the received beam B1 towards the light sensor 272.

FIG. 17B shows a situation wherein the light beam B1, which is reflected towards the monitoring fluid line 170 by the reflective surface 275, is transmitted through the monitoring fluid line 170 towards the reflective surface 277. The reflective surface 277 is oriented at an angle to reflect the beam B1 towards the light sensor 273. This situation occurs when fluid is present in the monitoring fluid line 170, as the refractive index changes such that the light beam B1 is transmitted by the monitoring fluid line 170 and the fluid inside.

FIG. 17C shows the self-testing mode of the sensing unit 270. Light is emitted by both light sources 271 and 274 without fluid present in the monitoring fluid line 170. The reflective surface 275 reflects light received from light source 271 in beam B1 towards the monitoring fluid line 170, and reflective surface 278 reflects light received from light source 274 in beam B2 towards the monitoring fluid line 170. The lack of fluid in the monitoring fluid line 170, the monitoring fluid line 170 instead containing gas such as air causes the refractive index to be such that both beams B1 and B2 are reflected to respectively reflective surfaces 276 and 277. The self-testing mode is used to verify the correct alignment of the cartridge 100 on the base system 200.

FIG. 18 shows an embodiment of the disposable cartridge 100 wherein use is made of a vial (sealed reservoir) containing a pre-made microvesicle suspension (the external microvesicle suspension) 1501. The vial (sealed reservoir) 1501 is mounted in a holder 1506 on the disposable cartridge 100, and connected to connector 1505, which can be the same connector 102 as is used to connect the cartridge 100 to a subject. The connection is made by means of a reservoir fluid conduit, preferably a flexible tube 1503 and a tube connector 1504. A cap 1502 is arranged on the vial 1501 which comprises a spike and a vent (not shown) for opening the vial 1501 and allowing external microvesicle suspension to flow out of it. The embodiment shown does not comprise the parts 150-156, shown in FIG. 4. Said parts are used to hold, open and transfer fluid from a sealed reservoir containing the second fluid, which is a liquid containing lipids from which microvesicles can be generated. These parts may be removed for versions of the disposable cartridge making use of pre-made microvesicle suspension, also referred to as the external microvesicle suspension, but this is not required. A visual code scanner, such as a barcode scanner or a QR-code scanner 1507 is arranged on the base system 200 and preferably protruding such that the QR-code scanner 1507 has a view of the underside of the vial 150/1501, which is arranged to scan a visual, machine readable code such as a barcode or QR-code on a vial 150/1501, preferably on its underside, mounted on the cartridge 100. Said scanner 1507 is also compatible with embodiments of the cartridge arranged for generating microvesicles, such as shown in FIG. 4. The location of the QR-code scanner 1507 in FIG. 18 is purely for illustrative purposes, and is not intended to limit the position of the QR-code scanner to the shown location.

FIG. 19A, B show the operation of the movable connector shield 1021, which is arranged to selectively cover or uncover the connector 102, 1505. In the closed, covered position in 19A, the movable connector shield 1021 covers the connector 102, 1505 preventing another connector from being connected to the connector 102, 1505. It is not essential that the entirety of the connector 102, 1505 is covered by the connector shield 1021, preferably at least part of the connector 102, 1505 is covered to prevent another connector from being connected to it. In the open, uncovered position shown in FIG. 19B the connector 102, 1505 is unobstructed to allow another connecter to be connected to it.

FIG. 20A, B shows the components that make up the cartridge pressure detection unit. FIG. 20A shows the pressure detection point 129 on the cartridge 100, which is also indicated in FIG. 5, in more detail. The pressure detection point 129 comprises a pressure transducer 1291, such as a bellow type member 1291, that transfers a force Fp which is proportional to the fluid pressure in the various fluid lines in the cartridge, more specifically the fluid pressure in the pressure detection point fluid cavity 1290. FIG. 20B shows the pressure sensing unit 229, also indicated in FIG. 7, in more detail. The pressure sensing unit 229 comprises a force transmission member 2292, which transfers the force Fp which is applied to a flat tip 2291 of the force transmission member 2292 to a force sensor 2293. The force Fp is the product of the pressure in the pressure detection point 129 and the contact area of the flat tip 2291. The force transmission member 2292 is mounted in the base system 200, and connected to the base system 200 by means of resilient members 2297, preferably linear guidance flexures 2297. These linear guidance flexures 2297 allow a linear movement of the force transmission member 2292 without friction and the resulting hysteresis. The linear guidance flexures 2297 are globally ring shaped, and connect to the base system 200 at their outer edges 2297a. The flexures 2297 are further made up of a plurality of folded members 2297b. The fact that these are folded allow a the folded members 2297b to be longer without increasing the overall footprint of the linear guidance flexures 2297. At the end of the force transmission member 2292 which contacts the force sensor 2293, a cylindrical cavity 2294 is arranged, comprising a biasing means 2295 and a plunger 2296. The force Fp is transmitted by the force transmission member 2292, to the biasing means 2295, then to the plunger 2296 and finally to the force sensor 2293. The biasing means 2295 is preferably a coil spring. The biasing means is preloaded to allow a force up to a predetermined threshold to be transmitted to the force sensor 2293, above which threshold the biasing means is compressed, and the plunger 2296 travels into the cavity 2294. A possible arrangement of the rigid stop 2298 arranged to stop the movement of the force transmission member after a set distance, and absorb any force above the force threshold, preventing forces higher than the threshold from being applied to the force sensor 2293 is shown in FIG. 20B. Preferably, the rigid stop is instead provided in the base system 200 at a location corresponding to the underside of the flat tip 2291 of the force transmission member 2292, such that the underside of the flat tip 2291 impacts the rigid stop. This location of the rigid stop increases the stiffness of the component that transfers the force impacted on the flat tip 2291 to the rigid stop, as only the flat tip 2291 transfers said force, instead of a larger portion of the force transmission member 2292.

FIG. 21A, B show a cross section of the base system 200, in particular along a plane cross sectioning the nozzle (outlet) 231, the valve actuators 291, and 293, as well as the heat transfer element 261. The nozzles (outlets) 231 and 232 are movably arranged in the base system, in FIG. 21A they are shown in the retracted position, and in FIG. 21B they are shown in the extended position. In the retracted position shown in FIG. 21B, they are covered by an outlet shield 233 which is also slidably arranged in the base system 200. The outlet shield 233 additionally comprises seals 234, in particular O-rings, which form a seal with the tips of the nozzles 231, 232 when the nozzles are pressed against said seals 234. To reach this sealing state, the nozzles 231, 232 are first retracted towards the retracted position, then the outlet shield 233 is closed, and then the nozzles 231, 232 are partially extended, thereby pressing against the seals 234 to seal the openings of the nozzles 231, 232. In FIG. 21B the outlet shield 233 is in the uncovering, open, position. The nozzles 231, 232 may then move to the extended position. Preferably, as the nozzles 231, 232, in particular the nozzle 231, move from the extended to the retracted position, the gas flow towards said nozzle(s) is cut off.

FIG. 22 shows a schematic overview of the mixing unit 197, which is arranged to combine a flow 1972 of microvesicle carrier liquid, preferably saline, from the secondary reservoir 180, and a flow 1971 of fluid, preferably heterogeneous microvesicle containing mixture or external microvesicle suspension from the holding unit 140, preferably being uniformized in said holding unit 140, into a combined flow of fluid 1973. The combined flow 1973 then flows toward the connector 102 and the subject connected to said connector. The geometry of the mixing unit, which comprises a junction of the fluid channels through which the flows 1971 and 1972 flow, has an impact on the mixing of the two fluids. Preferably, a T-junction is used wherein the flows 1971 and 1972 flow towards each other in in directly opposite directions, which are thus parallel directions, and the combined flow exits in a perpendicular direction, is used. The flow rates of flow 1972 from the secondary reservoir and of flow 1971 from the holding unit 140 can be varied, thereby allowing for a variation of the ratio of the two flows, by varying the speeds of respectively the secondary movable piston member 185 and the movable piston member 142.

The following embodiments are further provided for illustrative purposes:
1. System for generating microvesicles, in particular microbubbles, having a predefined size and/or size distribution, the system comprising:
   a microvesicle generating unit for generating microvesicles having a predefined size and/or size distribution, wherein said microvesicles generating unit comprises an inlet side that is arranged for receiving, through a first inlet, a first and, through a second inlet, a second fluid that are to be mixed by the microvesicle generating unit for generating the microvesicles and an outlet side that is arranged downstream and is arranged for expelling generated microvesicles;
   means for receiving said generated microvesicles in in a microvesicle carrier liquid for obtaining a microvesicle containing heterogeneous mixture;
   a holding unit for holding the microvesicle containing heterogeneous mixture comprising the generated microvesicles and the microvesicle carrier liquid, in particular a saline solution;
   a uniformization mechanism that is arranged for uniformizing of the microvesicle containing heterogeneous mixture held in the holding unit.
2. System according to embodiment 1, wherein the holding unit comprises means for expelling said microvesicle containing heterogeneous mixture from the holding unit for administering said microvesicle containing heterogeneous mixture to a subject, preferably wherein said holding unit is in fluid communication with a connector, wherein said connector preferably is of the luer type, that is arranged for coupling an infusion line that is arranged to be brought in fluid communication with the circulatory system of said subject.
3. System according to any of the preceding embodiments, wherein the holding unit comprises a holding container wherein a movable piston member is arranged, wherein the holding container and movable piston member enclose an interior volume for holding said microvesicle containing heterogeneous mixture and wherein said movable piston member is movable in the holding container for increasing or decreasing the internal volume, such that the said microvesicle containing heterogeneous mixture can be diluted, by adding the microvesicle carrier liquid to said microvesicle containing heterogeneous mixture in the holding unit, or be expelled from the holding unit, in particular the holding container, wherein said movable piston member is preferably arranged to be driven by a first driving mechanism, in particular comprising a linear drive.
4. System according to embodiment 3, wherein a ratio between a volumetric change of the interior volume due to a unit length of stroke of the movable piston member multiplied by the unit length of stroke of the movable piston and the frontal surface area of the movable piston member multiplied by the unit length of stroke of the movable piston is ≤1. Such a ratio allows for a precise control of the amount of, and flow rate with which, the mixture that is administered.
5. System according to any of the preceding embodiments, wherein the uniformization mechanism comprises a movable mixing element that extends into the holding unit; and
   wherein the system comprises a uniformization driving mechanism, in particular comprising a rotary drive, for driving said movable mixing element.
6. System according to at least embodiments 3 and 5, wherein the movable mixing element is comprised in the movable piston member, wherein the movable piston member is linearly movable inside the holding container and wherein the movable mixing element is a rotating mixing element, preferably comprising a plurality of fins that extend inside said interior volume, and is arranged to rotate with, or with respect to, the movable piston member;
   wherein, preferably, the movable piston member and movable mixing element comprise a shared shaft, wherein said shared shaft is rotatably connected to the movable mixing element and translationally connected to the movable piston member.
7. System according to any of the preceding embodiments, comprising a base system and a removably connected disposable cartridge, wherein said base system comprises releasable connecting means for holding the disposable cartridge in a predefined location and a predefined orientation, wherein said disposable cartridge comprises the microvesicle generation unit, the means for receiving said generated microvesicles in in a microvesicle carrier liquid, the holding unit and at least a part of the uniformization mechanism.
8. System according to any of the preceding embodiments, wherein the second fluid is comprised in a sealed reservoir that is, or can be, arranged in the system, in particular in a sealed container receiving section for receiving and holding said sealed container that is arranged in the disposable cartridge, and, wherein, when the system is in an initialization state, the sealed reservoir is arranged to be opened, and
   wherein the system, in particular the disposable cartridge, is arranged such that the second fluid in the opened container can be brought into fluid communication with the microvesicle generating unit.
9. System according to embodiment 8, wherein the sealed reservoir is, at least arranged to be, held within the system, in particular is arranged to be received in a sealed container receiving section for receiving and holding said sealed container that is arranged in within the cartridge, and wherein an opening tool, e.g. a cutting, puncturing and/or rupturing tool, is arranged to be moved with respect to the sealed reservoir and/or sealed container receiving section, or vice versa, to open the seal of the sealed reservoir for opening said sealed reservoir and wherein, preferably, a reservoir fluid conduit is arranged in, or with, the opening tool, wherein the reservoir fluid conduit is such, in the initialization state, an open end of the conduit is arranged to be inserted in the second fluid for bringing the second fluid in fluid communication with the microvesicle generating unit, wherein the system comprises an opening tool driving mechanism, in particular a linear driving mechanism, for driving the opening tool with respect to the sealed reservoir, or vice versa.
10. System according to any of the preceding embodiments 8-9, wherein the system comprises a primary pressure regulation gaseous medium source, in particular a pressurized air source, that is arranged to be, when the system is in a microvesicle generating state that follows the initialization state, in fluid communication with the opened reservoir for forcing a flow of second fluid to the microvesicle generating unit.
11. System according to any of the preceding embodiments, wherein the system comprises a secondary pressure regulation gaseous medium source that is arranged for providing, as the first fluid, a flow of the pressurized gaseous medium and/or wherein said second fluid is a continuous phase liquid.
12. System according to at least embodiment 7 and 10 or at least embodiment 7 and 11, wherein the base system comprises the primary and/or secondary pressure regulation gaseous medium source and a primary and/or secondary gaseous medium outlet(s);
   wherein the disposable cartridge comprises a primary and/or secondary gaseous medium cartridge inlet(s) that is/are arranged to engage and cooperate with the primary and/or secondary gaseous medium outlet(s) for arranging a fluid connection between the primary and/or secondary pressure regulation gaseous medium source and the microvesicle generating unit;
   wherein said primary and/or secondary gaseous medium inlet(s) is/are preferably movably arranged in the cartridge and preferably comprise biasing means for urging said inlet(s), when in a state wherein the cartridge is coupled to the base system, towards the base system and/or
   wherein said primary and/or secondary gaseous medium outlet(s) is/are preferably movably arranged in the base system and preferably comprise biasing means for urging said outlet(s), as seen in a state wherein the cartridge is coupled to the base system, towards the cartridge.
13. System according to at least embodiment 7, wherein the system comprises a locking mechanism having a released and locked state, wherein, in the released state, the disposable cartridge is removable from the base system and wherein, in the locked state, the disposable cartridge in fixedly held in the base system and urged, by the locking system, towards the base station with a preload force, wherein the locking system preferably comprises a locking drive mechanism for driving said locking mechanism.
14. System according to embodiment 13, wherein the locking mechanism comprises a first movable, in particular rotatable, clamping unit that is arranged in the base station and arranged to engage a first clamping portion of the cartridge, that is preferably arranged at a lower section of the disposable cartridge, and urge said clamping portion in a first direction towards the base station and urge said clamping portion in a second direction that substantially parallel to the base station and preferably perpendicular to the first direction and wherein the locking mechanism further comprises a second movable clamping unit that is arranged to engage the cartridge at a second clamping portion that is different from the first clamping position, that is preferably arranged at an upper section of the disposable cartridge, and urge said second location in the first direction.
15. System according to at least embodiments 13 and 14, wherein, in the locked state, the locking mechanism, in particular the respective movable clamping units, is arranged for applying the preload force onto a section of the cartridge comprising the, preferably movable, first and/or second gaseous medium inlet(s).
16. System according to at least embodiment 7, wherein the base system and disposable cartridge comprise mutually cooperating recesses and protrusions for aligning said disposable cartridge in the base system, preferably wherein said cooperating recesses and protrusions are arranged such that the cartridge only has a single unique fit with which it can be placed and coupled in the base system.
17. System according to any of the preceding embodiments, wherein the microvesicle generating unit comprises a microfluidic chip, in particular a microfluidic flow-focusing chip, comprising a first chip inlet for receiving the first fluid and a second chip inlet for receiving the second fluid, wherein channels extending from the first and second chip inlet converge at a junction from which a microvesicle formation channel extends towards a chip outlet for expelling the generated microvesicles from the microfluidic chip towards the outlet side of the microvesicle generating unit.
18. System according to embodiment 17, wherein the system further comprises a heat transfer element that is arranged for heating and/or cooling said a microfluidic chip.
19. System according to at least embodiments 7 and 18, wherein the heat transfer element is arranged in base system and is arranged to abut, in at least a connected state wherein the disposable cartridge is connected to the base system, a section of the cartridge comprising the microfluidic chip, in particular to directly abut the microfluidic chip.
20. System according to embodiment 19, wherein the heat transfer element is movably arranged within the base system along the direction towards, and away from, the disposable cartridge and wherein the heat transfer element is urged, by means of a heat transfer element biasing mechanism, in the direction towards the disposable cartridge.
21. System according to at least embodiment 7, wherein a respective driving mechanism comprises a driving unit, such as an electric, pneumatic or hydraulic motor, and wherein a driving unit of a respective driving mechanism is arranged in the base system and releasably and operatively coupled to a part of the respective driving mechanism that is arranged in the disposable cartridge.
22. System according any of the preceding embodiments, wherein the system, in particular the disposable cartridge, comprises a secondary sealed reservoir containing a saline solution, wherein, in the initialization phase, the secondary sealed reservoir is arranged to be opened and arranged to be in fluid communication with the holding unit or wherein the secondary sealed reservoir is arranged to be opened upon coupling, and/or locking, of disposable cartridge in the base system.
23. System according to embodiment 22, wherein the secondary sealed reservoir comprises a movable sealing element that is, before use, arranged to remain in a sealing position wherein the movable sealing element seals the secondary sealed reservoir and that, when in the initialization phase, is moved to an opening position, and/or wherein the base system may be arranged with fixedly arranged protruding member that is arranged to abut and push the movable sealing element from an opening of the secondary sealed reservoir upon the coupling, and/or locking, of said cartridge, such that the secondary reservoir is brought in fluid communication with the holding unit, in particular the holding container.
24. System according to embodiment 22 or 23, wherein the secondary sealed reservoir is arranged to be opened by increasing an internal pressure in the secondary sealed reservoir to a predefined minimum pressure.
25. Disposable cartridge for use in the system according to at least embodiment 7.
26. Base system for use in the system according to at least embodiment 7.

The present invention is not limited to the embodiment shown, but extends also to other embodiments falling within the scope of the appended claims.

1-80. (canceled)

81. A system for providing microvesicles, in particular microbubbles, having a predefined size and/or size distribution, the system comprising:
means for receiving microvesicles in a microvesicle carrier liquid for obtaining a microvesicle containing heterogeneous mixture;
a holding unit for holding the microvesicle containing heterogeneous mixture comprising the microvesicles and the microvesicle carrier liquid, in particular a saline solution;
a uniformization mechanism that is arranged for uniformizing of the microvesicle containing heterogeneous mixture held in the holding unit; and
a secondary reservoir containing microvesicle carrier liquid, in particular a saline solution, wherein the secondary reservoir is arranged in fluid connection with the holding unit.

82. The system according to claim 81, further comprising a microvesicle generating unit for generating microvesicles having a predefined size and/or size distribution, wherein said microvesicles generating unit comprises an inlet side that is arranged for receiving, through a first inlet, a first and, through a second inlet, a second fluid that are to be mixed by the microvesicle generating unit for generating the microvesicles and an outlet side that is arranged downstream and is arranged for expelling generated microvesicles.

83. The system according to claim 81, wherein the holding unit comprises means for expelling said microvesicle containing heterogeneous mixture from the holding unit for administering said microvesicle containing heterogeneous mixture to a subject, preferably wherein said holding unit is in fluid communication with a connector, wherein said connector preferably is of the luer type, that is arranged for coupling an infusion line that is arranged to be brought in fluid communication with the circulatory system of said subject, further comprising a mixing unit in fluid communication with at least the holding unit and the connector via an outlet, wherein the mixing unit further comprises an inlet for receiving microvesicle carrier liquid, in particular saline, wherein the mixing unit is arranged to combine the microvesicle containing heterogeneous mixture from the holding unit and microvesicle carrier liquid to the outlet for supply to the connector.

84. The system according to claim 83, wherein the system is arranged to adjust the ratio of the microvesicle containing heterogeneous mixture and microvesicle carrier liquid flowing into the mixing unit.

85. The system according to claim 81, wherein the holding unit comprises a holding container wherein a movable piston member is arranged, wherein the holding container and movable piston member enclose an interior volume for holding said microvesicle containing heterogeneous mixture and wherein said movable piston member is movable in the holding container for increasing or decreasing the internal volume, such that the said microvesicle containing heterogeneous mixture can be diluted, by adding the microvesicle carrier liquid to said microvesicle containing heterogeneous mixture in the holding unit, or be expelled from the holding unit, in particular the holding container, wherein said movable piston member is preferably arranged to be driven by a first driving mechanism, in particular comprising a linear drive.

86. The system according to claim 81, wherein the uniformization mechanism comprises a movable mixing element that extends into the holding unit; and wherein the system comprises a uniformization driving mechanism, in particular comprising a rotary drive, for driving said movable mixing element.

87. The system according to claim 86, wherein the uniformization driving mechanism is arranged to alternatingly rotate the movable mixing element in the clockwise and counterclockwise directions.

88. The system according to claim 86, wherein the movable mixing element is comprised in the movable piston member, wherein the movable piston member is linearly movable inside the holding container and wherein the movable mixing element is a rotating mixing element, preferably comprising a plurality of fins that extend inside said interior volume, and is arranged to rotate with, or with respect to, the movable piston member.

89. The system according to claim 88, wherein the uniformization driving mechanism further comprises a releasable coupling for releasably coupling the movable piston member and/or the rotatable mixing element to the driving mechanism, wherein the releasable coupling comprises one or more movable annular coupling members comprising a protrusion arranged to engage with a recess or groove arranged on the movable piston member.

90. The system according to claim 82, comprising a base system and a removably connected disposable cartridge, wherein said base system comprises releasable connecting means for holding the disposable cartridge in a predefined location and a predefined orientation, wherein said disposable cartridge comprises the means for receiving generated microvesicles in in a microvesicle carrier liquid, the holding unit and at least a part of the uniformization mechanism.

91. The system according to claim 90, wherein the disposable cartridge further comprises the microvesicle generating unit.

92. The system according to claim 82, wherein the second fluid is comprised in a sealed reservoir that is, or can be, arranged in the system, in particular in a sealed reservoir receiving section for receiving and holding said sealed reservoir that is arranged in the disposable cartridge, and, wherein, when the system is in an initialization state, the sealed reservoir is arranged to be opened, and wherein the system, in particular the disposable cartridge, is arranged such that the second fluid in the opened reservoir can be brought into fluid communication with the microvesicle generating unit.

93. The system according to claim 92, wherein the sealed reservoir is, at least arranged to be, held within the system, in particular is arranged to be received in a sealed reservoir receiving section for receiving and holding said sealed reservoir that is arranged in within the cartridge, and wherein an opening tool, e.g. a cutting, puncturing and/or rupturing tool, is arranged to be moved with respect to the sealed reservoir and/or sealed reservoir receiving section, or vice versa, to open the seal of the sealed reservoir for opening said sealed reservoir and wherein, preferably, a reservoir fluid conduit is arranged in, or with, the opening tool, wherein the reservoir fluid conduit is such, in the initialization state, an open end of the conduit is arranged to be inserted in the second fluid for bringing the second fluid in fluid communication with the microvesicle generating unit, wherein the system comprises an opening tool driving mechanism, in particular a linear driving mechanism, for driving the opening tool with respect to the sealed reservoir, or vice versa.

94. The system according to claim 81, wherein the system is arranged for receiving generated microvesicles in an external microvesicle suspension, comprising pre-made microvesicles in a microvesicle carrier liquid, in the holding unit, wherein the external microvesicle suspension is comprised in a sealed reservoir that is, or can be, arranged in the system, in particular in a sealed reservoir receiving section for receiving and holding said sealed reservoir that is arranged in the disposable cartridge, and wherein the system, in particular the disposable cartridge, is arranged such that the external microvesicle suspension in the opened reservoir can be brought into fluid communication with the holding unit, and wherein, preferably, a reservoir fluid conduit is arranged to bring the external microvesicle suspension in fluid communication with the holding unit.

95. The system according to claim 91, wherein the base system comprises the primary and/or secondary pressure regulation gaseous medium source and a primary and/or secondary gaseous medium outlet(s);
wherein the disposable cartridge comprises a primary and/or secondary gaseous medium cartridge inlet(s) that is/are arranged to engage and cooperate with the primary and/or secondary gaseous medium outlet(s) for arranging a fluid connection between the primary pressure regulating gaseous medium source and the sealed reservoir, and/or the secondary pressure regulation gaseous medium source and the microvesicle generating unit;
wherein said primary and/or secondary gaseous medium inlet(s) is/are preferably movably arranged in the cartridge and preferably comprise biasing means for urging said inlet(s), when in a state wherein the cartridge is coupled to the base system, towards the base system; and/or
wherein said primary and/or secondary gaseous medium outlet(s) is/are preferably movably arranged in the base system and preferably comprise biasing means for urging said outlet(s), as seen in a state wherein the cartridge is coupled to the base system, towards the cartridge.

96. The system according to claim 95, wherein the system comprises a locking mechanism having a released and locked state, wherein, in the released state, the disposable cartridge is removable from the base system and wherein, in the locked state, the disposable cartridge in fixedly held in the base system and urged, by the locking system, towards the base system with a preload force, wherein the locking system preferably comprises a locking drive mechanism for driving said locking mechanism.

97. The system according to claim 95, wherein the base system and disposable cartridge comprise mutually cooperating recesses and protrusions for aligning said disposable cartridge in the base system, preferably wherein said cooperating recesses and protrusions are arranged such that the cartridge only has a single unique fit with which it can be placed and coupled in the base system.

98. The system according to claim 82, wherein the microvesicle generating unit comprises a microfluidic chip, in particular a microfluidic flow-focusing chip, comprising a first chip inlet for receiving the first fluid and a second chip inlet for receiving the second fluid, wherein channels extending from the first and second chip inlet converge at a junction from which a microvesicle formation channel extends towards a chip outlet for expelling the generated microvesicles from the microfluidic chip towards the outlet side of the microvesicle generating unit.

99. The system according to claim 81, further comprising a sensing unit comprising a first light source and a first light sensor, further comprising a monitoring fluid line wherein light originating from the first light source is directed through the monitoring fluid line towards the first light sensor in the presence of the microvesicle containing heterogeneous mixture in the monitoring fluid line, wherein the sensing unit is arranged to determine the concentration of microvesicles in the microvesicle containing heterogeneous mixture based on the intensity of light received by the first light sensor.

100. The system according to claim 99, wherein the system further comprises a second light sensor, wherein light originating from the first light source which is reflected by the monitoring fluid line is directed towards the second light sensor, wherein the sensing unit is arranged to determine the presence of gas in the monitoring fluid line based on light received by the second light sensor.
